(19) United States
(12) Patent Application Publication
(10) Pub. No.: US 2021/0074455 A1
(43) Pub. Date: Mar. 11, 2021

(54) RARE EARTH MAGNET AND PRODUCTION METHOD THEREOF

(71) Applicant: TOYOTA JIDOSHA KABUSHIKI KAISHA, Toyota-shi (JP)

(72) Inventors: Noritsugu SAKUMA, Mishima-shi (JP); Tetsuya SHOJI, Susono-shi (JP); Yukio TAKADA, Nagakute-shi (JP)

(73) Assignee: TOYOTA JIDOSHA KABUSHIKI KAISHA, Toyota-shi (JP)

(21) Appl. No.: 17/004,270

(22) Filed: Aug. 27, 2020

(30) Foreign Application Priority Data
Sep. 10, 2019 (JP) 2019-164896

(51) Int. Cl. H01F 1/057; H01F 41/02

(52) U.S. Cl. CPC H01F 1/0577; H01F 41/0293

(57) ABSTRACT

A rare earth magnet 100 including a main phase 10 and a grain boundary phase 20. The overall composition is represented by the formula: (R²₍₁₋ₓ₎R¹ₓ)_{y}Fe_{(100-y-w-z-v)}Co_{w}B_{z}M¹ᵥ.(R³₍₁₋ₚ₎M²ₚ)_{q}. R¹ is an element selected from Ce, La, Y, and Sc. R² and R³ is an element selected from Nd, Pr, Gd, Tb, Dy, and Ho. M¹ is a predetermined element, etc. M² is a transition metal element, etc. The average particle dimeter of the main phase 10 is from 1 to 20 μm. The main phase 10 has a core portion 12 and a shell portion 14. The thickness of the shell portion 14 is from 25 to 150 nm. The “a” is the ratio of the light rare earth element of the core portion 12 and the “b” is the ratio of the light rare earth element of the core portion 12. These satisfy 0≤b≤0.30 and 0≤b/a≤0.50.

### TECHNICAL FIELD

The present disclosure relates to a rare earth magnet and a production method thereof. More specifically, the present disclosure relates to an R—Fe—B-based rare earth magnet (wherein R is a rare earth element) excellent in both the coercive force and the residual magnetization and a production method thereof.

### BACKGROUND ART

The R—Fe—B-based rare earth magnet includes a main phase and a grain boundary phase present around the main phase. The main phase is a magnetic phase having an R₂Fe₁₄B-type crystal structure. High residual magnetization is obtained due to this main phase. However, in the R—Fe—B-based rare earth magnet, magnetization reversal readily occurs between main phases to reduce the coercive force. To solve this problem, in the R—Fe—B-based rare earth magnet, it is common practice to magnetically separate main phases from one another by using a modifier and thereby enhance the coercive force.

Among R—Fe—B-based rare earth magnets, a Nd—Fe—B-based rare earth magnet (neodymium magnet) has an excellent balance between the performance and the cost and is most popular. Accordingly, the Nd—Fe—B-based rare earth magnet has spread rapidly, and the use amount of Nd is sharply increased, leaving the possibility that the use amount of Nd surpasses the production in the future. To cope with this issue, attempts to replace part of Nd by a light rare earth element such as Ce, La, Y and Sc are being made.

For example, Patent Literature 1 discloses a rare earth magnet produced by using, as a precursor, an R—Fe—B-based rare earth magnet containing a light rare earth element and diffusing and infiltrating a modifier containing a rare earth element except for a light rare earth element into the inside of the precursor. Specifically, a rare earth magnet produced by diffusing and infiltrating a Nd—Cu alloy as a modifier into a (Nd, Ce)—Fe—B-based rare earth magnet precursor is disclosed.

At the production of the rare earth magnet disclosed in Patent Literature 1, a rare earth magnet precursor with the main phase being nanocrystallized is used. In addition, the rare earth magnet precursor is previously subjected to hot plastic working before diffusing and infiltrating a modifier, and anisotropy is thereby imparted in the hot plastic working direction even after the diffusion and infiltration of the modifier.

### CITATION LIST

### Patent Literature

[PTL 1] International Publication WO2014/196605A1

### SUMMARY OF INVENTION

### Technical Problem

In the R—Fe—B-based rare earth magnet, the coercive force is enhanced by diffusing and infiltrating a modifier into a rare earth magnet precursor. The rare earth magnet precursor includes a main phase and a grain boundary phase present around the main phase, and the modifier diffuses and infiltrates mainly into the grain boundary phase. The modifier contains a rare earth element and a transition metal element. The transition metal element can be alloyed with the rare earth element. Hereinafter, such a transition metal element is sometimes referred to as “alloy element of the modifier”. In the case where, for example, an Nd—Cu alloy is used as the modifier, Nd can be alloyed with Cu, and the melting point of the modifier is thereby reduced. Accordingly, the modifier can be diffused and infiltrated into a rare earth magnet precursor at a relatively low temperature. When the modifier diffuses and infiltrates into a rare earth magnet precursor, the content of an alloy element of the modifier is increased in the grain boundary phase, and this makes it possible to magnetically separate the main phases from one another and enhance the coercive force. However, when the content of an alloy element of the modifier is increased in the grain boundary phase, the volume fraction of the main phase that develops magnetism decreases, and the residual magnetization is reduced.

Various attempts to compensate for the reduction in the residual magnetization are being made. For example, in the production method of a rare earth magnet disclosed in Patent Literature 1, a rare earth magnet precursor with the main phase being nanocrystallized is used so as to enhance in advance the residual magnetization of a rare earth magnet precursor and thereby compensate for the reduction in the residual magnetization after the diffusion and infiltration of a modifier. In addition, as in the production method disclosed in Patent Literature 1, a modifier containing a rare earth element (for example, Nd, etc.) other than a light rare earth element is diffused and infiltrated into a rare earth magnet precursor containing a light rare earth element (for example, Ce, etc.) so as to replace Ce, etc. in the vicinity of the surface layer part of the main phase of the rare earth magnet precursor by Nd, etc., and the residual magnetization of the main phase after the diffusion and infiltration of the modifier is thereby enhanced to compensate for reduction in the residual magnetization.

As the method to compensate for reduction in the residual magnetization, it may be considered to decrease the content of the alloy element of the modifier. However, when the content of the alloy element of the modifier is decreased, the melting point of the modifier increases, and this requires the diffusion and infiltration to be performed at a high temperature. In consequence, coarsening of the nanocrystallized main phase arises as a problem during diffusion and infiltration of the modifier.

The conventional attempt to compensate for the reduction of the residual magnetization disclosed in Patent Literature 1 has achieved a certain result. However, the demand for performance improvement of rare earth magnets is more increasing, and it is also increasingly likely that the cost of Nd, etc. soars. Under these circumstances, the present inventors have found a problem to be solved that an R—Fe—B-based rare earth magnet excellent in both the coercive force and the residual magnetization is desired also in the case of using a light rare earth element for at least part of the rare earth element.

The rare earth magnet of the present disclosure and the production method thereof have been invented so as to solve the problem above. An object of the present disclosure is to provide an R—Fe—B-based rare earth magnet excellent in both the coercive force and the residual magnetization also in the case of using a light rare earth element for at least part of the rare earth element, and a production method thereof.

### Solution to Problem

The present inventors have made many intensive studies to attain the object above and have accomplished the rare earth magnet of the present disclosure and the production method thereof. The rare earth magnet of the present disclosure and the production method thereof includes the following embodiments.

<1> A rare earth magnet including a main phase and a grain boundary phase present around the main phase, wherein the overall composition is represented, in terms of molar ratio, by the formula: (R²₍₁₋ₓ₎R¹ₓ)_{y}Fe_{(100-y-w-z-v)}Co_{w}B_{z}M¹_{y} (R³₍₁₋ₚ₎M²ₚ)_{q} (wherein R¹ is one or more elements selected from the group consisting of Ce, La, Y, and Sc, each of R² and R³ is one or more elements selected from the group consisting of Nd, Pr, Gd, Tb, Dy, and Ho, M¹ is composed of one or more elements selected from the group consisting of Ga, Al, Cu, Au, Ag, Zn, In, and Mn, and unavoidable impurity elements, M² is composed of a transition metal element which is other than a rare earth element and can be alloyed with R³, and unavoidable impurity elements,

0.1≤x≤1.0,

12.0≤y≤20.0,

5.0≤z≤20.0,

0≤w≤8.0,

0≤v≤2.0,

0.05≤p≤0.40, and

0.1≤q≤15.0),

the main phase has an R₂Fe₁₄B-type (wherein R is a rare earth element) crystal structure,

the average particle diameter of the main phase is from 1 to 20 μm,

the main phase has a core portion and a shell portion present around the core portion,

the thickness of the shell portion is from 25 to 150 nm, and

with respect to the core portion, denoting a as the molar ratio of the total content of Ce, La, Y, and Sc relative to the total content of Ce, La, Y, Sc, Nd, Pr, Gd, Tb, Dy, and Ho, and with respect to the shell portion, denoting b as the molar ratio of the total content of Ce, La, Y, and Sc relative to the total content of Ce, La, Y, Sc, Nd, Pr, Gd, Tb, Dy, and Ho, these satisfy 0≤b≤0.30 and 0≤b/a≤0.50.

<2> The rare earth magnet according to item <1>, wherein b satisfies from 0.09 to 0.27 and b/a satisfies from 0.17 to 0.47.

<3> The rare earth magnet according to item <1> or <2>, wherein z is from 5.6 to 20.0.

<4> A method for producing a rare earth magnet, including:

preparing a rare earth magnet precursor which includes a main phase and a grain boundary phase present around the main phase and in which the overall composition is represented, in terms of molar ratio, by the formula: (R²₍₁₋ₓ₎R¹ₓ)_{y}Fe_{(100-y-w-z-v)}Co_{w}B_{z}M¹_{y}(wherein R¹ is one or more elements selected from the group consisting of Ce, La, Y, and Sc, R² is one or more elements selected from the group consisting of Nd, Pr, Gd, Tb, Dy, and Ho, M¹ is composed of one or more elements selected from the group consisting of Ga, Al, Cu, Au, Ag, Zn, In, and Mn, and unavoidable impurity elements, and 0.1≤x≤1.0, 12.0≤y≤20.0, 5.0≤z≤20.0, 0≤w≤8.0, and 0≤v≤2.0 are satisfied), the main phase has an R₂Fe₁₄B-type (wherein R is a rare earth element) crystal structure, the average particle diameter of the main phase is from 1 to 20 μm, and the volume fraction of the main phase is from 90 to 97%,

preparing a modifier having a composition represented, in terms of molar ratio, by the formula: R³₍₁₋ₚ₎M²ₚ (wherein R³ is one or more elements selected from the group consisting of Nd, Pr, Gd, Tb, Dy, and Ho, M² is composed of a transition metal element which is other than a rare earth element and can be alloyed with R³, and unavoidable impurity elements, and 0.05≤p≤0.40), and

bringing q parts by mol (0.1≤q≤15.0) of the modifier into contact with 100 parts by mol of the rare earth magnet precursor to diffuse and infiltrate from 3.7 to 10.0 parts by mol of R³ relative to the total of the rare earth magnet precursor and the modifier (100 parts by mol+q parts by mol) at a temperature of not less than the melting point of the modifier and from 750 to 1,000° C.

<5> The method according to item <4>, wherein from 3.6 to 10.4 parts by mol of the modifier is diffused and infiltrated into 100 parts by mol of the rare earth magnet precursor.

<6> The method according to item <4>, wherein from 3.8 to 7.8 parts by mol of R³ is diffused and infiltrated relative to the total of the rare earth magnet precursor and the modifier (100 parts by mol+q parts by mol).

<7> The method according to any one of items <4> to <6>, wherein

z in the formula representing the composition of the rare earth magnet precursor is from 5.6 to 20.0,

the grain boundary phase of the rare earth magnet precursor contains from 0 to 30.0 vol % of a phase having an R_{1.1}Fe₄B₄-type crystal structure relative to the entire rare earth magnet precursor, and

the composition of the modifier is represented, in terms of molar ratio, by the formula: R³₍₁₋ₛ₋ₜ₎FeₛM³ₜ (wherein M³ is composed of a transition metal element which is other than a rare earth element and can be alloyed with R³ and Fe, and unavoidable impurity elements, and 0.05≤s≤0.30, 0≤t≤0.20, and 0.05≤s+t≤0.40 are satisfied).

<8> The method according to any one of items <4> to <7>, wherein the rare earth magnet after diffusing and infiltrating the modifier into the rare earth magnet precursor is further heat-treated for optimization at 450 to 600° C.

<9> The method according to any one of items <4> to <8>, wherein after the diffusion and infiltration, the rare earth magnet precursor and the modifier are cooled at 0.1 to 10° C./min.

<10> The method according to anyone of items <4> to <8>, wherein after the diffusion and infiltration, the rare earth magnet precursor and the modifier are cooled at 0.1 to 1° C./min.

<11> The method according to anyone of items <4> to <10>, wherein the modifier is diffused and infiltrated into the rare earth magnet precursor at a temperature of not less than the melting point of the modifier and from 850 to 1,000° C.

<12> The method according to anyone of items <4> to <10>, wherein the modifier is diffused and infiltrated into the rare earth magnet precursor at a temperature of not less than the melting point of the modifier and from 900 to 1,000° C.

### Advantageous Effects of Invention

According to the present disclosure, the R—Fe—B-based rare earth magnet in which the average particle diameter of the main phase including a core portion and a shell portion is from 1 to 20 μm, the shell portion has a predetermined thickness, and the concentration of the light rare earth element in the shell portion is in a predetermined range, can be provided. As a result, the R—Fe—B-based rare earth magnet excellent in both the coercive force and the residual magnetization even in the case of using a light rare earth element for at least part of the rare earth element can be provided.

Furthermore, according to the present disclosure, the modifier is diffused and infiltrated into the rare earth magnet precursor at not less than the predetermined temperature, and the production method of the above-described R—Fe—B-based rare earth magnet excellent in both the coercive force and the residual magnetization can thereby be provided.

### BRIEF DESCRIPTION OF DRAWINGS

FIG. 1 is an explanatory diagram schematically illustrating the state where a modifier is put into contact with a rare earth magnet precursor.

FIG. 2A is an explanatory diagram illustrating the state where a modifier is diffused and infiltrated into a rare earth magnet precursor at a high temperature.

FIG. 2B is an explanatory diagram illustrating the state where a Fe-containing modifier is diffused and infiltrated into a rare earth magnet precursor at a high temperature.

FIG. 2C is an explanatory diagram illustrating the state where a modifier is diffused and infiltrated into a rare earth magnet precursor at a low temperature.

FIG. 3A is an explanatory diagram schematically illustrating the structure of a rare earth magnet after diffusing and infiltrating a modifier at a high temperature.

FIG. 3B is a diagram schematically illustrating the structure of a rare earth magnet after diffusing and infiltrating a Fe-containing modifier at a high temperature.

FIG. 3C is a diagram schematically illustrating the structure of a rare earth magnet after diffusing and infiltrating a modifier at a low temperature.

FIG. 4 is a schematic diagram illustrating a composition range where an R_{1.1}Fe₄B₄ phase is likely to be formed.

FIG. 5 is a Fe—Nd phase diagram.

FIG. 6 is a graph illustrating the relationship between the diffusion/infiltration temperature and the coercive force with respect to the samples of Examples 1 to 10 and Comparative Examples 1 to 5.

FIG. 7A is a diagram illustrating the results when the sample of Example 9 is observed by SEM.

FIG. 7B is a diagram illustrating the results when area analysis of Fe is performed using SEM-EDX with respect to the region shown in FIG. 7A.

FIG. 7C is a diagram illustrating the results when area analysis of La is performed using SEM-EDX with respect to the region shown in FIG. 7A.

FIG. 7D is a diagram illustrating the results when area analysis of Ce is performed using SEM-EDX with respect to the region shown in FIG. 7A.

FIG. 7E is a diagram illustrating the results when area analysis of Nd is performed using SEM-EDX with respect to the region shown in FIG. 7A.

FIG. 8 is a graph illustrating the relationship between the coercive force and the residual magnetization with respect to the samples of Examples 11 to 18 and Comparative Examples 6 to 9.

FIG. 9 is a diagram illustrating a composition range of the rare earth magnet precursors of Examples 19 and 20 and Comparative Example 10.

FIG. 10A is a diagram illustrating the results when the sample of Example 25 is observed by SEM.

FIG. 10B is a diagram illustrating the results when area analysis of Fe is performed using SEM-EDX with respect to the region shown in FIG. 10A.

FIG. 10C is a diagram illustrating the results when area analysis of La is performed using SEM-EDX with respect to the region shown in FIG. 10A.

FIG. 10D is a diagram illustrating the results when area analysis of Ce is performed using SEM-EDX with respect to the region shown in FIG. 10A.

FIG. 10E is a diagram illustrating the results when area analysis of Nd is performed using SEM-EDX with respect to the region shown in FIG. 10A.

FIG. 11A is a diagram illustrating the results when the sample of Comparative Example 13 is observed by SEM.

FIG. 11B is a diagram illustrating the results when area analysis of Fe is performed using SEM-EDX with respect to the region shown in FIG. 11A.

FIG. 11C is a diagram illustrating the results when area analysis of La is performed using SEM-EDX with respect to the region shown in FIG. 11A.

FIG. 11D is a diagram illustrating the results when area analysis of Ce is performed using SEM-EDX with respect to the region shown in FIG. 11A.

FIG. 11E is a diagram illustrating the results when area analysis of Nd is performed using SEM-EDX with respect to the region shown in FIG. 11A.

FIG. 12 is a graph illustrating the relationship between the temperature and the coercive force with respect to the samples of Example 37 and Comparative Example 14.

FIG. 13 is a graph illustrating the relationship between the temperature and the residual magnetization with respect to the samples of Example 37 and Comparative Example 14.

FIG. 14A is a diagram illustrating the results when the sample of Example 37 is observed by Cs-STEM.

FIG. 14B is a diagram illustrating the results when area analysis of Ce is performed using Cs-STEM-EDX with respect to the region shown in FIG. 14A.

FIG. 14C is a diagram illustrating the results when area analysis of Nd is performed using Cs-STEM-EDX with respect to the region shown in FIG. 14A.

FIG. 15A is a diagram illustrating the results when the portion surrounded by a square in FIG. 15A is enlarged and observed by Cs-STEM.

FIG. 15B is a diagram illustrating the results when the portion surrounded by a square in FIG. 15A is enlarged and area analysis of Ce is performed using Cs-STEM-EDX.

FIG. 15C is a diagram illustrating the results when the portion surrounded by a square in FIG. 15A is enlarged and area analysis of Nd is performed using Cs-STEM-EDX.

### DESCRIPTION OF EMBODIMENTS

The embodiments of the rare earth magnet according to the present disclosure and the production method thereof are described in detail below. Incidentally, the embodiments set forth below should not be construed to limit the rare earth magnet according to the present disclosure and the production method thereof.

Although not bound by theory, with respect to the reason why even in the case of using a light rare earth element for at least part of the rare earth element, an R—Fe—B-based rare earth magnet excellent in both the coercive force and the residual magnetization is obtained, the matters found by the present inventors are described using the drawings.

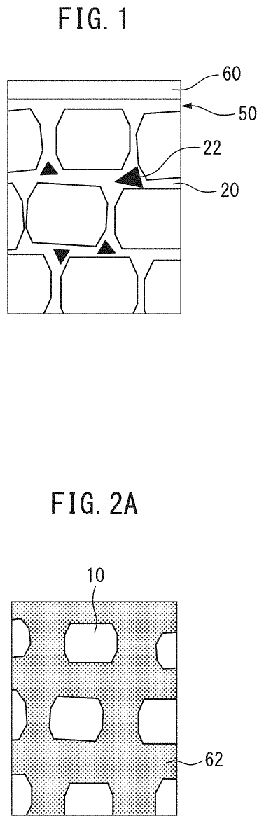

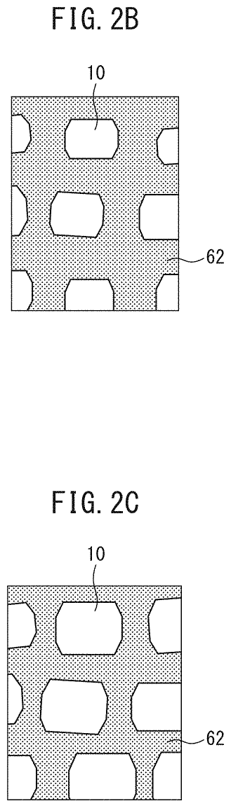

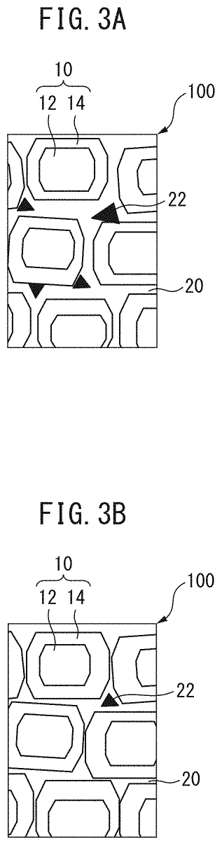

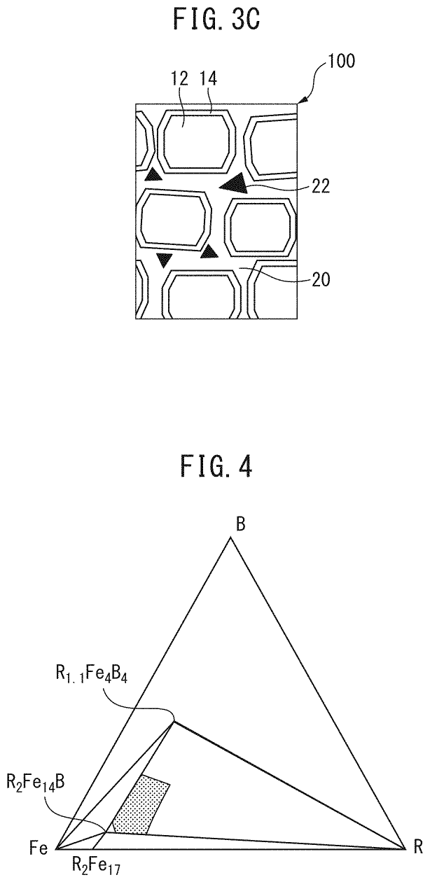

FIG. 1 is an explanatory diagram schematically illustrating the state where a modifier is put into contact with a rare earth magnet precursor. FIG. 2A is an explanatory diagram schematically illustrating the state where a modifier is diffused and infiltrated into a rare earth magnet precursor at a high temperature. FIG. 2B is an explanatory diagram illustrating the state where a Fe-containing modifier is diffused and infiltrated into a rare earth magnet precursor at a high temperature. FIG. 2C is an explanatory diagram illustrating the state where a modifier is diffused and infiltrated into a rare earth magnet precursor at a low temperature. FIG. 3A is an explanatory diagram schematically illustrating the structure of a rare earth magnet after diffusing and infiltrating a modifier at a high temperature. FIG. 3B is a diagram schematically illustrating the structure of a rare earth magnet after diffusing and infiltrating a Fe-containing modifier at a high temperature. FIG. 3C is a diagram schematically illustrating the structure of a rare earth magnet after diffusing and infiltrating a modifier at a low temperature.

FIG. 1, FIG. 2A and FIG. 3A are a diagram explaining one example of the rare earth magnet of the present disclosure and the production method thereof. FIG. 1, FIG. 2B and FIG. 3B are a diagram explaining another example of the rare earth magnet of the present disclosure and the production method thereof. FIG. 1, FIG. 2C and FIG. 3C are a diagram explaining one example of the rare earth magnet of the present disclosure and the production method thereof.

In order to diffuse and infiltrate a modifier into a rare earth magnet precursor, for example, as illustrated in FIG. 1, a modifier 60 is put into contact with a rare earth magnet precursor 50. The rare earth magnet precursor 50 includes a main phase 10 and a grain boundary phase 20. The grain boundary phase 20 is present around the main phase 10. The grain boundary phase 20 may contain a triple point 22. The main phase 10 has an R₂Fe₁₄B-type crystal structure, and the triple point 22 has an R_{1.1}Fe₄B₄-type crystal structure.

When the rare earth magnet precursor 50 and the modifier 60 are heated at a temperature of not less than the melting point of the modifier 60 in the state of being put into contact with each other as illustrated in FIG. 1, the melt 62 of the modifier 60 diffuses and infiltrates into the grain boundary phase 20 as illustrated in FIG. 2A, FIG. 2B, and FIG. 2C. Then, the triple point 22 melts in the grain boundary phase 20, and the portion near the surface layer part of the main phase 10 melts in the main phase 10. In the case of diffusing and infiltrating the modifier at a high temperature (see, FIG. 2A and FIG. 2B), the melt zone near the surface layer part of the main phase 10 is deep, compared with the case of diffusing and infiltrating the modifier at a low temperature (see, FIG. 2C). This occurs because in the case of diffusing and infiltrating the modifier at a high temperature, an element present in the main phase 10 readily diffuses into the melt 62 of the modifier 60, compared with the case of diffusing and infiltrating the modifier at a low temperature.

With the progress of cooling from the state illustrated in FIG. 2A, FIG. 2B and FIG. 2C, the melted portion near the surface layer part of the main phase 10 re-solidifies to form a shell portion 14. Thus, as illustrated in FIG. 3A, FIG. 3B, and FIG. 3C, the main phase 10 is divided into a core portion 12 and a shell portion 14 (the core portion 12 is unchanged from before diffusion and infiltration). At the time of formation of the shell portion 14, at least part of the light rare earth element (for example, Ce, etc.) of the main phase 10 before diffusion and infiltration is, in the shell portion 14, replaced by a rare earth element (for example, Nd of a Nd—Cu alloy) other than a light rare earth element of the modifier.

In the case where the modifier is diffused and infiltrated at a high temperature (see, FIG. 2A) and then cooled (see, FIG. 3A), compared with the case where the modifier is diffused and filtrated at a low temperature (see, FIG. 2C) and then cooled (see, FIG. 3C), the shell portion 14 is thick, and the concentration of the rare earth element (for example, Nd of a Nd—Cu alloy) other than the light rare earth element of the modifier is high in the shell portion 14. Hereinafter, “the concentration of the rare earth element (for example, Nd of a Nd—Cu alloy) other than the light rare earth element of the modifier is high” is sometime simply referred to as “the concentration of the rare earth element of the modifier is high”. In addition, “the concentration of the rare earth element (for example, Nd of a Nd—Cu alloy) other than the light rare earth element of the modifier is low” is sometime simply referred to as “the concentration of the rare earth element of the modifier is low”.

Even when the same amount of the modifier 60 is diffused and infiltrated into the rare earth magnet precursor 50, the shell portion 14 is thin (see, FIG. 3C) in the case of diffusing and infiltrating the modifier at a low temperature, and the shell portion 14 is thick (see, FIG. 3A) in the case of diffusing and infiltrating the modifier at a high temperature. In addition, when the modifier is diffused and infiltrated at a low temperature, the concentration of the rare earth element of the modifier is low in the shell portion 14, compared with the case of diffusing and infiltrating the modifier at a high temperature. On the other hand, when the modifier is diffused and infiltrated at a high temperature, the concentration of the rare earth element of the modifier is high in the shell portion 14.

The shell portion 14 is part of the main phase 10, and therefore the shell portion 14 has an R₂Fe₁₄B-type crystal structure, and a higher residual magnetization is obtained when R is Nd (Nd₂Fe₁₄B) than when R is Ce (Ce₂Fe₄B). In the shell portion 14, at least part of the light rare earth element (for example, Ce, etc.) before diffusion and infiltration is replaced by the rare earth element (for example, Nd of a Nd—Cu alloy) of the modifier. Accordingly, unless the volume fraction of the shell potion 14 in the main phase 10 becomes excessively large, as the shell portion 14 is thicker, the residual magnetization can be more enhanced. Furthermore, in the shell portion 14, as the concentration of the rare earth element (for example, the concentration of Nd of a Nd—Cu alloy) of the modifier is higher, the residual magnetization can be more enhanced. As understood from these, the residual magnetization can be more enhanced when the modifier is diffused and infiltrated at a high temperature than when diffused and infiltrated at a low temperature.

Regarding the diffusion infiltration temperature, the “low temperature” means a diffusion infiltration temperature at which when the main phase of the rare earth magnet precursor is nanocrystallized, coarsening of the main phase can be substantially avoided. Here, the “nanocrystallized” means that the average particle diameter of the main phase is 1 nm or more and less than 1,000 nm. On the other hand, the “high temperature” means a diffusion infiltration temperature at which when a magnetic rare earth magnet obtained by pressureless sintering is used as a rare earth magnet precursor, coarsening of the main phase can be substantially avoided. The average particle diameter of the main phase of the rare earth magnet obtained by pressureless sintering is from 1 to 20 μm. Details of the diffusion infiltration temperature are described later.

The rare earth magnet of the present disclosure is obtained by diffusing and infiltrating the modifier at a “high temperature”, and therefore it is difficult to use a rare earth magnet precursor having a nanocrystallized main phase (hereinafter, sometimes referred to as “nanocrystalline rare earth magnet precursor”). At the production of the rare earth magnet of the present disclosure, a rare earth magnet precursor with the main phase having an average particle size of 1 to 20 μm (hereinafter, sometimes referred to as “microcrystalline rare earth magnet precursor”) is used. Therefore, in the rare earth magnet of the present disclosure and the production method thereof, the effect of enhancement of residual magnetization due to nanocrystallization of the main phase can hardly be enjoyed. However, the present inventors have found that the residual magnetization can be more enhanced when the modifier is diffused and infiltrated at a “high temperature” into a microcrystalline rare earth magnet precursor, than when the modifier is diffused and infiltrated at a “low temperature” into a nanocrystalline rare earth magnet precursor. As a result, the present inventors have reached the finding that even when a light rare earth element is used for at least part of the rare earth element, an R—Fe—B-based rare earth magnet excellent in both the coercive force and the residual magnetization is obtained.

In addition, with the progress of cooling from the state illustrated in FIG. 2A, in addition to the formation of the shell portion 14, a triple point 22 is re-formed as illustrated in FIG. 3A. The triple point 22 is a phase having an R_{1.1}Fe₄B₄-type crystal structure (the phase having such a crystal structure is, hereinafter, sometimes referred to as “R_{1.1}Fe₄B₄ phase”). In the R_{1.1}Fe₄B₄ phase, compared with a phase having an R₂Fe₁₄B-type crystal structure (the phase having such a crystal structure is, hereinafter, sometimes referred to as “R₂Fe₁₄B phase”), the content ratios of R and B are high, and the content ratio of Fe is low. In addition, the R₂Fe₁₄B phase is stable compared with the R_{1.1}Fe₄B₄ phase.

FIG. 2A and FIG. 3A illustrate an aspect where a modifier 60 substantially free from Fe is diffused and infiltrated into a rare earth magnet precursor 50. FIG. 2B and FIG. 3B illustrate an aspect where a modifier 60 containing from Fe is diffused and infiltrated into a rare earth magnet precursor 50. In an aspect where the modifier is substantially free from Fe, an R_{1.1}Fe₄B₄ phase is re-formed as a triple point 22 as illustrated in FIG. 2A and FIG. 3A. On the other hand, as illustrated in FIG. 2B and FIG. 3B, in an aspect where the modifier contains Fe, an R_{1.1}Fe₄B₄ phase is not re-formed as a triple point 22, but an R₂Fe₁₄B phase is re-formed and works out to part of the main phase 10 (the main phase 10 grows). The present inventors have found that the volume fraction of the main phase 10 is thereby increased and in turn, the residual magnetization is further enhanced.

The configuration requirements of the rare earth magnet according to the present disclosure and the production method thereof, based on these findings, are described below.

### «Rare Earth Magnet»

First, the configuration requirements of the rare earth magnet according to the present disclosure are described. As illustrated in FIG. 3A and FIG. 3B, the rare earth magnet 100 of the present disclosure includes a main phase 10 and a grain boundary phase 20. The grain boundary phase 20 is present around the main phase 10. The main phase 10 has a core portion 12 and a shell portion 14. The shell portion 14 is present around the core portion 12. The overall composition, main phase 10 and grain boundary phase 20 of the rare earth magnet 100 of the present disclosure are described below. In addition, with respect to the main phase 10, the core portion 12 and the shell portion 14 are described.

### <Overall Composition>

The overall composition of the rare earth magnet 100 of the present disclosure is described. The overall composition of the rare earth magnet 100 of the present disclosure means a composition combining all main phases 10 and grain boundary phases 20 in FIG. 3A and FIG. 3B. As described above, the main phase 10 has a core portion 12 and a shell portion 14. In the case where a triple point 22 is present, the triple point 22 is included in the grain boundary phase 20.

The overall composition in terms of molar ratio of the rare earth magnet 100 of the present disclosure is represented by the formula: (R²₍₁₋ₓ₎R¹ₓ)_{y}Fe_{(100-y-w-z-v)}Co_{w}B_{z}M¹ᵥ.(R³₍₁₋ₚ₎M²ₚ)_{q}. In the formula, (R²₍₁₋ₓ₎Rₓ)_{y}Fe_{(100-y-w-z-v)}Co_{w}B_{z}M¹ᵥ represents a composition derived from a rare earth magnet precursor, and (R³₍₁₋ₚ₎M²ₚ)_{q} represents a composition derived from a modifier.

The rare earth magnet 100 of the present disclosure is obtained by diffusing and infiltrating a modifier having a composition represented by the formula: R³₍₁₋ₚ₎M²ₚ into the inside of a rare earth magnet precursor having a composition represented by the formula: (R²₍₁₋ₓ₎R¹ₓ)_{y}Fe_{(100-y-w-z-v)}Co_{w}B_{z}M¹ᵥ. When q parts by mol of a modifier is diffused and infiltrated into the inside of 100 parts by mol of a rare earth magnet precursor, the volume of the rare earth magnet after diffusing and infiltrating the modifier into the rare earth magnet precursor is (100+q) parts by mol. The formula above shows this, and since the total of R¹ and R² is y parts by mol, Fe is (100-y-w-z-v) parts by mol, Co is w parts by mol, B is z parts by mol, and M¹ is v parts by mol, the total of these is y parts by mol+(100-y-w-z-v) parts by mol+w parts by mol+z parts by mol+v parts by mol=100 parts by mol. The total of R³ and M² is p parts by mol.

In the formula above, R²₍₁₋ₓ₎R¹ₓ means that in terms or molar ratio, (1-x)R² and xR¹ are present relative to the total of R² and R³. Similarly, in the formula above, R³₍₁₋ₚ₎M²ₚ means that in terms of molar ratio, (1-p)R³ and pM³ are present relative to the total of R³ and M³.

In the formula above, R¹ is one or more elements selected from the group consisting of Ce, La, Y, and Sc. Ce is cerium, La is lanthanum, Y is yttrium, and Sc is scandium. Each of R² and R³ is one or more elements selected from the group consisting of Nd, Pr, Gd, Tb, Dy, and Ho. Nd is neodymium, Pr is praseodymium, Gd is gadolinium, Tb is terbium, Dy is dysprosium, and Ho is holmium. Fe is iron, Co is cobalt, and B is boron. M¹ is composed of one or more elements selected from the group consisting of Ga, Al, Cu, Au, Ag, Zn, In, and Mn, and unavoidable impurity elements. Ga is gallium, Al is aluminum, Cu is copper, Au is gold, Ag is silver, Zn is zinc, In is indium, and Mn is manganese. M² is composed of a transition metal element which is other than a rare earth element and can be alloyed with R³, and unavoidable impurity elements.

In the present description, the rare earth element consists of 17 elements of Sc, Y, La, Ce, Pr, Nd, Pm, Sm, Eu, Gd, Tb, Dy, Ho, Er, Tm, Yb, and Lu. Among these, Sc, Y, La, and Ce are light rare earth elements. Pr, Nd, Pm, Sm, Eu, and Gd are medium rare earth elements. Tb, Dy, Ho, Er, Tm, Yb, and Lu are heavy rare earth elements. Incidentally, in general, the rarity of the heavy rare earth element is high, and the rarity of the light rare earth element is low. The rarity of the medium rare earth element is between the heavy rare earth element and the light rare earth element.

The constituent elements of the rare earth magnet of the present disclosure, represented by the formula above, is described below.

### <R¹>

R¹ is an essential component for the rare earth magnet of the present disclosure. As described above, R¹ is one or more elements selected from the group consisting of Ce, La, Y, and Sc and belongs to the light rare earth element. R¹ is an element constituting the main phase (R₂Fe₁₄B phase). At least part of R¹ in the vicinity of the surface layer part of the main phase is replaced by R³ in the modifier, and the main phase can thereby have a core portion and a shell portion.

### <R²>

As described above, R² is one or more elements selected from the group consisting of Nd, Pr, Gd, Tb, Dy, and Ho and belongs to the rare earth element other than the light rare earth element. Nd, Pr, and Gd belong to the medium rare earth element, and Tb, Dy, and Ho belong to the heavy rare earth element. In other words, R² belongs to the medium rare earth element and/or the heavy rare earth element. In the rare earth magnet of the present disclosure, in view of the balance between the performance and cost, it is preferable to increase the contents of Nd and Pr, and it is more preferable to increase the content of Nd. In the case where Nd and Pr are caused to coexist as R¹, didymium may be used. R² is an element constituting the main phase (R₂Fe₁₄B phase).

<Molar Ratios of R¹ and R²>

In the rare earth magnet of the present disclosure, R¹ and R² are elements derived from a rare earth magnet precursor. Relative to the total of R¹ and R², in terms of molar ratio, xR¹ is present, and (1-x)R² is present, wherein 0.1≤x≤1.0.

As illustrated in FIG. 2A and FIG. 3A, since R¹ present in the vicinity of the surface layer part of the main phase 10 is replaced by R³ of the modifier and the shell portion 14 is thereby formed, R¹ is mandatorily present even in a small amount. When x is 0.1 or more, formation of the shell portion 14 can be substantially recognized. In view of the formation of the shell portion 14, x may be 0.2 or more, 0.3 or more, 0.4 or more, 0.5 or more, 0.6 or more, 0.7 or more, 0.8 or more, 0.9 or more, or 1.0. When x is 1.0, this means that relative to the total amount of R¹ (light rare earth element) and R² (rare earth element other than light rare earth element), all are R¹ (light rare earth element).

In the R₂Fe₁₄B phase (main phase), the anisotropic magnetic field (coercive force) and the residual magnetization are higher when the rare earth element other than the light rare earth element is contained as R in a larger amount than the light rare earth element. R¹ (light rare earth element) and R² (rare earth element other than light rare earth element) are derived from the rare earth magnet precursor. By diffusing and infiltrating the modifier into the rare earth magnet precursor, in the portion near the surface layer part of the main phase 10, at least part of R¹ (light rare earth element) of the rare earth magnet precursor is replaced by R³ (rare earth element other than light rare earth element) of the modifier, whereby a shell portion 14 is formed. In the case where the main phase has a core portion 12 and a shell portion 14, the anisotropic magnetic field (coercive force) and residual magnetic field of the rare earth magnet as a whole can be efficiently enhanced by enhancing the anisotropic magnetic field (coercive force) and residual magnetization in the shell portion 14 than in the core portion 12. This implies that even when all are an inexpensive R¹ (light rare earth element) in the core portion 12, it is sufficient if R¹ (light rare earth element) is replaced by R³ (rare earth element other than light rare earth element) in the shell portion 14.

<Total Content Ratio of R¹ and R²>

In the formula above, the total content ratio of R¹ and R² is represented by y and satisfies 12.0≤y≤20.0. Here, the value of y is a content ratio relative to the rare earth magnet precursor and corresponds to at %.

When y is 12.0 or more, in the rare earth magnet precursor, a large amount of αFe phase cannot be present, and a sufficient amount of main phase (R₂Fe₁₄B phase) can be obtained. From this viewpoint, y may be 12.4 or more, 12.8 or more, or 13.2 or more. On the other hand, when y is 20.0 or less, the grain boundary phase cannot be excessive. From this viewpoint, y may be 19.0 or less, 18.0 or less, or 17.0 or less.

### <B>

B constitutes the main phase 10 (R₂Fe₁₄B phase) as illustrated in FIG. 2A and FIG. 3A and affects the abundance ratios of the main phase 10 and the grain boundary phase 20 and the abundance ratio of the triple point 22 (R_{1.1}Fe₄B₄ phase) in the grain boundary phase 20.

The content ratio of B is represented by z in the formula above. The value of z is a content ratio relative to a rare earth magnet precursor and corresponds to at %. When z is 20.0 or less, a rare earth magnet where the main phase 10 and the grain boundary phase 20 are properly present can be obtained. From this viewpoint, z may be 18.0 or less, 16.0 or less, 14.0 or less, 12.0 or less, 10.0 or less, or 8.0 or less. On the other hand, when z is 5.0 or more, generation of a large amount of a phase having Th₂Zn₁₇ and/or Th₂Ni₁₇-type crystal structures hardly occurs, as a result, the formation of R₂Fe₁₄B is less inhibited. In addition, when z is 5.6 or more, the R_{1.1}Fe₄B₄ phase is likely to be produced as the triple point 22 in the grain boundary phase 20. From this viewpoint, z may be 5.8 or more, 6.0 or more, 6.2 or more, 6.4 or more, 6.6 or more, 6.8 or more, or 7.0 or more. When many R_{1.1}Fe₄B₄ phases are formed as the triple point 22 in the grain boundary phase 20 and a Fe-containing modifier is diffused and infiltrated, R_{1.1}Fe₄B₄ is changed to R₂Fe₁₄B phase due to Fe of the modifier, and the volume fraction of the main phase increases, as a result, the residual magnetization is further enhanced.

### <Co>

Co is an element capable of being replaced by Fe in the main phase and the grain boundary phase. In the present description, when Fe is referred to, this means that part of Fe can be replaced by Co. For example, part of Fe of the R₂Fe₁₄B phase is replaced by Co to form a R²(Fe, Co)₁₄B phase. In addition, for example, part of Fe of the R_{1.1}Fe₄B₄ phase in the grain boundary phase is replaced by Co to form R_{1.1}(Fe, Co)₄B₄.

The R₂Fe₁₄B phase is changed to R₂(Fe, Co)₁₄B phase due to replacing of part of Fe by Co, and in turn, the Curie point of the rare earth magnet of the present disclosure increases. In addition, when a Fe-containing modifier is diffused and infiltrated, the R_{1.1}(Fe, Co)₄B₄ phase changes to R₂(Fe, Co)₁₄B phase, and therefore the Curie point of the rare earth magnet of the present disclosure increases. In the case of not desiring the increase of the Curie point, Co may not be contained, and it is not mandatory to contain Co.

In the formula above, the content ratio of Co is represented by w. The value of w is a content ratio relative to the rare earth magnet precursor and corresponds to at %. When w is 0.5 or more, an increase of the Curie point is substantially recognized. From the viewpoint of increasing the Curie point, w may be 1.0 or more, 2.0 or more, 3.0 or more, or 4.0 or more. On the other hand, since Co is expensive, from the economical viewpoint, w may be 30.0 or less, 25.0 or less, 20.0 or less, 10.0 or less, 8.0 or less, 7.0 or less, or 6.0 or less.

### <M¹>

M¹ can be contained to an extent of not impairing the properties of the rare earth magnet of the present disclosure. M¹ may contain unavoidable impurity elements. In the present description, the unavoidable impurity elements indicates impurity elements that is inevitably contained or causes a significant rise in the production cost for avoiding its inclusion, such as impurity elements contained in raw materials of the rare earth magnet or impurity elements having mixed in the production step. The impurity elements, etc. that mixes in the production step encompasses an element that is contained to an extent of not affecting the magnetic properties for the reason of production convenience, and the unavoidable impurity elements encompasses an element that is an element other than the rare earth element selected as R¹ and R² and inevitably mixes for the above-described reasons.

The element that can be contained to an extent of not impairing the effects of the rare earth magnet of the present disclosure and the production method thereof includes Ga, Al, Cu, Au, Ag, Zn, In, and Mn. As long as the amount in which these elements are present is not more than the upper limit of the content of M¹, the elements have substantially no influence on the magnetic properties. Accordingly, the elements above may be treated as equivalent to unavoidable impurity elements. Furthermore, besides these elements, unavoidable impurity elements can be contained as M¹,

In the formula above, the content ratio of M¹ is represented by v. The value of v is a content ratio relative to the rare earth magnet precursor and corresponds to at %. When the value of v is 2.0 or less, the magnetic properties of the present disclosure are not impaired. From this viewpoint, v may be 1.5 or less, 1.0 or less, or 0.5 or less.

Ga, Al, Cu, Au, Ag, Zn, In, Mn, and unavoidable impurity elements, as M¹, cannot be made zero, and therefore, even if the lower limit of v is 0.05, 0.1, or 0.2, there is no practical problem.

### <Fe>

Fe is the remainder excluding hereinbefore-described R¹, R², Co, B, and M¹, and the content ratio of Fe is represented by (100-y-w-z-v). When y, w, z, and v are in the ranges described above, as illustrated in FIG. 3A and FIG. 3B, the main phase 10 and the grain boundary phase 20 are obtained.

### <R³>

R³ is an element derived from the modifier. As illustrated in FIG. 1, FIG. 2A and FIG. 3A, the modifier 60 diffuses and infiltrates into the inside of the rare earth magnet precursor 50. At least part of R¹ in the vicinity of the surface layer part of the main phase 10 is replaced by R³ of the modifier 60 to form a shell portion 14. Consequently, in the rare earth magnet 100 of the present disclosure, R³ is present in the shell portion 14 and the grain boundary phase 20.

R³ is one or more elements selected from the group consisting of Nd, Pr, Gd, Tb, Dy, and Ho and is a rare earth element (a medium rare earth element and a heavy rare earth element) other than the light rare earth element. As described above, at least part of R¹ (light rare-earth element) in the vicinity of the surface layer part of the main phase 10 is replaced by R³ (a rare earth element other than the light rare earth element) of the modifier 60, and the concentration of the rare earth element other than the light rare earth element in the shell portion 14 increases. As a result, the anisotropic magnetic field (coercive force) and residual magnetization of the rare earth magnet 100 of the present disclosure are enhanced.

### <M²>

M² is composed of a transition metal element which is other than a rare earth element and can be alloyed with R³, and unavoidable impurity elements. Typically, M² is composed of an alloy element which reduce the melting point of R³₍₁₋ₚ₎M²ₚ to be lower than the melting point of R³, and unavoidable impurity elements. M² includes, for example, one or more elements selected from Cu, Al, Co, and Fe, and unavoidable impurity elements. M² is preferably one or more elements selected from Cu, Al, and Fe. Furthermore, as described above, compared with the case where M² does not contain Fe (see, FIG. 3A), in the case where M² contains Fe (see, FIG. 3B), the R_{1.1}Fe₄B₄ of the triple point 22 is changed to constitute part of the main phase (R₂Fe₁₄B phase) due to Fe of the modifier 60. As a result, this contributes to more enhancement of the anisotropic magnetic field (coercive force) and residual magnetization of the rare earth magnet 100 of the present disclosure. Incidentally, in the present description, the unavoidable impurity elements indicates impurity elements that is inevitably contained or causes a significant rise in the production cost for avoiding its inclusion, such as impurity elements contained in raw materials of the rare earth magnet or impurity elements having mixed in the production step. The impurity elements, etc. having mixed in the production step encompasses an element that is contained to an extent of not affecting the magnetic properties for the reason of production convenience, and the unavoidable impurity elements encompasses an element that is an element except for the rare earth element selected as R³ and inevitably mixes for the above-described reasons.

<Molar Ratio of R³ and M²>

R³ and M² form an alloy having a composition represented, in terms of molar ratio, by the formula: R³₍₁₋ₚ₎M²ₚ, and the modifier contains this alloy, wherein p satisfies 0.05≤p≤0.40.

When p is 0.05 or more, a melt of the modifier 60 can be diffused and infiltrate into the inside of the rare earth magnet precursor 50 at a temperature where coarsening of the main phase 10 of the rare earth magnet precursor 50 can be avoided. From this viewpoint, p is preferably 0.07 or more, more preferably 0.09 or more. On the other hand, when p is 0.40 or less, the content of M² remaining in the grain boundary phase 20 of the rare earth magnet 100 of the present disclosure after diffusing and infiltrating the modifier 60 into the rare earth magnet precursor 50 is reduced, and this contributes to the enhancement of residual magnetization. From this viewpoint, p may be 0.35 or less, 0.30 or less, 0.25 or less, 0.20 or less, or 0.15 or less.

### <M³>

M² may or may not contain Fe, but, as described above, M² preferably contains Fe. In the case where M² contains Fe, for the sake of convenience, M² other than Fe may be rewritten as M³, and R³₍₁₋ₚ₎M²ₚ in the formula above may be rewritten as R³₍₁₋ₛ₋ₜ₎FeₛM³ₜ. At this time, M³ is composed of a transition metal element other than a rare earth element and Fe which can be with R³, and unavoidable impurity elements, and 0.05≤s≤0.30, 0≤t≤0.20, and 0.05≤s+t≤0.40 are satisfied. s and t are described in detail in “«Production Method»”.

Typically, M³ is composed of an alloy element, which reduce the melting point of R³₍₁₋ₛ₋ₜ₎FeₛM³ₜ to be lower than the melting points of R³ and Fe, and unavoidable impurity elements. M³ includes, for example, one or more elements selected from Cu, Al, Ga and Co.

<Molar Ratios of Element Derived from Rare Earth Magnet Precursor and Element Derived from Modifier>

In the formula above, the ratio of the modifier 60 relative to 100 parts by mol of the rare earth magnet precursor 50 is q parts by mol. More specifically, when q parts by mol of the modifier 60 is diffused and infiltrated into 100 parts by mol of the rare earth magnet precursor 50, this gives 100 parts by mol+q parts by mol of the rare earth magnet 100 of the present disclosure. Accordingly, assuming the total content of the elements derived from the rare earth magnet precursor is 100 parts by mol, q is the molar ratio of the content of the element derived from the modifier. In other words, the rare earth magnet 100 of the present disclosure is (100+q) at % relative to 100 at % of the rare earth magnet precursor 50.

When q is 0.1 or more, at least part of R¹ (light rare earth element) of the main phase 10 of the rare earth magnet precursor 50 can be replaced by R³ (a rare earth element other than a light rare earth element) of the modifier 60 and in turn, the shell portion 14 can be formed. As a result, the anisotropic magnetic field (coercive force) and residual magnetization of the rare earth magnet 100 of the present disclosure can be enhanced. From this viewpoint, q may be 0.5 or more, 1.0 or more, 1.5 or more, 2.0 or more, 2.5 or more, 3.0 or more, or 3.6 or more. On the other hand, when q is 15.0 or less, the content of M² remaining in the grain boundary phase 20 of the rare earth magnet 100 of the present disclosure is reduced, and this contributes to the enhancement of residual magnetization. From this viewpoint, q may be 14.0 or less, 13.0 or less, 12.0 or less, 11.0 or less, 10.4 or less, 10.0 or less, 9.5 or less, 9.0 or less, 8.5 or less, 8.0 or less, 7.5 or less, 7.0 or less, or 6.5 or less.

The rare earth magnet 100 of the present disclosure includes a main phase 10 and a grain boundary phase 20. The main phase 10 has a core portion 12 and a shell portion 14. The main phase 10 and the grain boundary phase 20 are described below. With respect to the main phase 10, the core portion 12 and the shell portion 14 are also described.

### <Main Phase>

The main phase 10 has a R₂Fe₁₄B-type crystal structure. R is a rare earth element. The reason why the crystal structure is expressed as R₂Fe₁₄B “-type” is because in the main phase 10 (in the crystal structure), elements other than R, Fe and B can be contained in a substitution-type and/or interstitial-type manner. For example, in the main phase 10, part of Fe may be replaced by Co, or in the main phase 10, part of any one element of R, Fe and B may be replaced by M¹. Alternatively, for example, M¹ may be present as an interstitial-type element in the main phase 10.

The average particle diameter of the main phase 10 is from 1 to 20 μm. In the case where the average particle diameter of the main phase 10 is 1 μm or more, even when a modifier is diffused and infiltrated at a high temperature, coarsening of the main phase 10 can be substantially avoided. From this viewpoint, the average particle diameter of the main phase may be 1.1 μm or more, 1.2 μm or more, 1.3 μm or more, 1.4 μm or more, 1.5 μm or more, 1.6 μm or more, 1.7 μm or more, 1.8 μm or more, 1.9 μm or more, 2.0 μm or more, 2.2 μm or more, or 2.4 μm or more. When the average particle diameter of the main phase 10 is 20 μm or less, a phenomenon that desired residual magnetization and/or coercive force cannot be obtained due to the particle diameter of the main phase 10 does not occur. From this viewpoint, the average particle diameter of the main phase 10 may be 18 μm or less, 16 μm or less, 14 μm or less, 12 μm or less, 10 μm or less, 9 μm or less, 8 μm or less, 7 μm or less, 6 μm or less, 5 μm or less, or 4 μm or less.

The “average particle diameter” is an average of maximum lengths of the main phases 10. The “average of maximum lengths” means an average of maximum lengths of respective main phases 10 present in a certain area after defining the certain area in a scanning electron microscope image or a transmission electron microscope image. For example, when the cross section of the main phase 10 is elliptical, the length of the major axis is the maximum length. For example, when the cross section of the main phase 10 is quadrangular, the length of a longer diagonal line is the maximum length. In addition, since the main phase 10 of the rare earth magnet 100 of the present disclosure has a core portion 12 and a shell portion 14, the maximum length of the main phase 10 is a maximum length including the shell portion 14. For example, as illustrated in FIG. 3A, the maximum length of the main phase 10 is the length indicated by L.

### <Core Portion and Shell Portion>

As illustrated in FIG. 3A, the main phase 10 of the rare earth magnet 100 of the present disclosure has a core portion 12 and a shell portion 14. The shell portion 14 is present around the core portion 12.

The anisotropic magnetic field (coercive force) and the residual magnetization of the rare earth magnet 100 as a whole of the present disclosure can be increased by more increasing the anisotropic magnetic field (coercive force) and residual magnetization in the shell portion 14 than in the core portion 12. In addition, a rare earth element (for example, Nd, etc.) of the modifier other than a light rare earth element is diffused and infiltrated into the shell portion 14, and this is advantageous for enhancing the anisotropic magnetic field (coercive force) and the residual magnetization. Accordingly, as long as the volume fraction of the shell portion 14 in the main phase 10 does not become excessive, the shell portion 14 preferably has a larger thickness. When the thickness of the shell portion 14 is 25 nm or more, the rare earth magnet 100 of the present disclosure can have desired anisotropic magnetic field (coercive force) and residual magnetization. From this viewpoint, the thickness of the shell portion 14 may be 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, or 90 nm or more. On the other hand, when the thickness of the shell portion 14 is 150 nm or less, the volume fraction of the shell portion 14 in the main phase is kept from becoming excessively large. From this viewpoint, the thickness of the shell portion 14 may be 140 nm or less, 130 nm or less, 120 nm or less, 125 nm or less, 120 nm or less, 115 nm or less, 110 nm or less, 105 nm or less, 100 nm or less, or 95 nm or less.

The thickness of the shell portion 14 means the distance between the outer circumference of the core portion 12 and the inner circumference of the shell portion 14. With respect to the method for measuring the thickness of the shell portion 14, after a certain area is defined, the distance above is measured in each of main phases 10 present in the certain area by using a scanning electron microscope or a transmission electron microscope, and the thickness is determined by averaging respective distances.

In order to more increase the anisotropic magnetic field (coercive force) and residual magnetization in the shell portion 14 than in the core portion 12, the concentration of the light rare earth element is more reduced (the concentration of the rare earth element other than the light rare earth element is more increased) in the shell portion 14 than in the core portion 12. For realizing this, the following indices should be satisfied.

With respect to the core portion 12, the molar ratio of the total content of Ce, La, Y, and Sc (the content of the light rare earth element) relative to the total content of Ce, La, Y, Sc, Nd, Pr, Gd, Tb, Dy, and Ho (the total of the content of the light rare earth element and the content of the rare earth element other than the light rare earth element) is denoted by a. In addition, with respect to the shell portion 14, the molar ratio of the total content of Ce, La, Y, and Sc (the content of the light rare earth element) relative to the total content of Ce, La, Y, Sc, Nd, Pr, Gd, Tb, Dy, and Ho (the total of the content of the light rare earth element and the content of the rare earth element other than the light rare earth element) is denoted by b. At this time, these satisfy 0≤b≤0.30 and 0≤b/a≤0.50.

b represents the molar ratio of the content of the light rare earth element relative to the content of all rare earth elements in the shell portion 14. When b is 0.30 or less, the concentration of the light rare earth element in the shell portion 14 is low (the concentration of the rare earth element other than the light rare earth element is high), and this is advantageous for enhancing the anisotropic magnetic field (coercive force) and the residual magnetization. b is preferably lower and may be 0. From this viewpoint, b may be 0.27 or less, 0.25 or less, 0.20 or less, 0.15 or less, 0.12 or less, or 0.10 or less.

When all light rare earth elements of the main phase 10 before diffusion and infiltration (the rare earth magnet precursor 50) are replaced by the rare earth element of the modifier other than the light rare earth element, b becomes 0. However, even if all are not replaced, there is practically no problem in enhancement of the anisotropic magnetic field (coercive force) and the residual magnetization. From this viewpoint, b may be 0.01 or more, 0.03 or more, 0.05 or more, 0.07 or more, or 0.09 or more.

When the molar ratio of the content of the light rare earth element to the content of all rare earth elements (hereinafter, sometimes simply referred to as “ratio of light rare earth element”) is low in both the core portion 12 and the shell portion 14, this is advantageous for enhancing the anisotropic magnetic field (coercive force) and the residual magnetization. In other words, when the molar ratio of the content of the rare earth element other than the light rare earth element to the content of all rare earth elements (hereinafter, sometimes simply referred to as “ratio of rare earth element other than light rare earth element”) is high in both the core portion 12 and the shell portion, this is advantageous for enhancing the anisotropic magnetic field (coercive force) and the residual magnetization.

It is advantageous for enhancing the anisotropic magnetic field (coercive force) and residual magnetization of the rare earth magnet 100 as a whole of the present disclosure to more enhance the anisotropic magnetic field (coercive force) and residual magnetization in the shell portion 14 than in the core portion 12. Accordingly, it is preferable to more reduce the ratio of the light rare earth element in the shell portion 14 than in the core portion 12, and b (ratio of light rare earth element in the shell portion 14)/a (ratio of light rare earth element in the core portion 12) is preferably smaller and may be 0. From this viewpoint, b/a may be 0.50 or less, 0.47 or less, 0.44 or less, 0.41 or less, 0.38 or less, 0.35 or less, 0.32 or less, 0.25 or less, 0.20 or less, or 0.15 or less.

On the other hand, b/a being 0 means that b is 0, i.e., in the shell portion 14, all rare earth elements are replaced by a rare earth element of the modifier other than the light rare earth element. However, even if all are not replaced, the enhancement of anisotropic magnetic field (coercive force) and residual magnetization is substantially recognized. From this viewpoint, it may be 0.01 or more, 0.03 or more, 0.05 or more, 0.07 or more, 0.09 or more, 0.10 or more, or 0.13 or more.

Incidentally, regarding the above-described “with respect to the core portion 12, the molar ratio of the total content of Ce, La, Y, and Sc relative to the total content of Ce, La, Y, Sc, Nd, Pr, Gd, Tb, Dy, and Ho is denoted by a”, and “with respect to the shell portion 14, the molar ratio of the total content of Ce, La, Y, and Sc relative to the total content of Ce, La, Y, Sc, Nd, Pr, Gd, Tb, Dy, and Ho is denoted by b”, a supplementary explanation is given below

Since the modifier does not diffuse and infiltrate into the core portion 12, all of Ce, La, Y, Sc, Nd, Pr, Gd, Tb, Dy, and Ho in the core portion 12 are derived from the rare earth element of the rare earth magnet precursor, that is, R¹ and R². On the other hand, since the modifier diffuses and infiltrates into the shell portion 14, Ce, La, Y, Sc, Nd, Pr, Gd, Tb, Dy, and Ho in the shell portion 14 are derived from the rare earth elements of the rare earth magnet precursor 50 and the modifier 60, that is, R¹, R², and R³. However, in the shell portion 14, as concerns Nd, Pr, Gd, Tb, Dy, and Ho, the element derived from R² and the element derived from R³ cannot be actually distinguished as “a material”. For this reason, R¹ and R² as well as R³ are not used when defining a, b and b/a.

Incidentally, a and b are determined based on the results of component analysis performed using Cs-STEM-EDX (Corrector-Spherical Aberration-Scanning Transmission Electron Microscope-Energy Dispersive X-ray Spectrometry). Because, it is not easy to separately observe the core portion 12 and the shell portion 14 by SEM-EDX (Scanning Electron Microscope-Energy Dispersive X-ray Spectrometry).

### <Grain Boundary Phase>

As illustrated in FIG. 3A and FIG. 3B, the rare earth magnet 100 of the present disclosure includes a main phase 10 and a grain boundary phase 20 present around the main phase 10. As described above, the main phase 10 contains a phase having an R₂Fe₁₄B-type crystal structure (R₂Fe₁₄B phase). On the other hand, the grain boundary phase 20 contains a phase whose crystal structure is indistinct, excluding the triple point 22. Although not bound by theory, the “indistinct phase” is a phase other than R₂Fe₁₄B phase and means a phase (state) where at least part of the phase has an incomplete crystal structure and they are irregularly present, or means a phase where at least part of the phase (state) above scarcely assumes the look of a crystal structure as if it is amorphous.

The crystal boundary phase 20 has an indistinct crystal structure but has a composition in which the content ratio of R in the grain boundary phase 20 as a whole is higher than in the main phase 10 (R₂Fe₁₄B phase). Accordingly, the grain boundary phase 20 is sometimes referred to as “R-rich phase”, “rare earth element-rich phase”, or “rare earth-rich phase”.

The grain boundary phase 20 may have an R_{1.1}Fe₄B₄ phase as the triple point 22. The triple point 22 corresponds to the solidified portion in the cooling step at the production of the rare earth magnet precursor 50, and the solidified portion may be an R_{1.1}Fe₄B₄ phase. The R_{1.1}Fe₄B₄ phase scarcely contributes to the anisotropic magnetic field (coercive force) and residual magnetization of the rare earth magnet 100 of the present disclosure. Therefore, it is preferred that, as described above, the R_{1.1}Fe₄B₄ phase is changed to an R₂Fe₁₄B phase by Fe in the modifier 60 to constitute part of the main phase 10.

### «Production Method»

The production method of the rare earth magnet of the present disclosure is described below.

### <Preparation of Rare Earth Magnet Precursor>

A rare earth magnet precursor 50 having an overall composition represented, in terms of molar ratio, by the formula: (R²₍₁₋ₓ₎Rₓ)_{y}Fe_{(100-y-w-z-v)}Co_{w}B_{z}M¹ᵥ is prepared. In the formula representing the overall composition of the rare earth magnet precursor 50, R¹, R², Fe, Co, B, M¹, x, y, z, w, and v are as described in “«Rare Earth Magnet»”.

As illustrated in FIG. 1, the rare earth magnet precursor 50 includes a main phase 10 and a grain boundary phase 20 present around the main phase 10. Since a modifier 60 is not diffused and infiltrated into the main phase 10 of the rare earth magnet precursor 50, a shell portion 14 is not formed, and the main phase 10 of the rare earth magnet precursor 50 is not divided into a core portion 12 and a shell portion 14. The main phase 10 of the rare earth magnet precursor has an R₂Fe₁₄B-type crystal structure.

In the production method of the rare earth magnet of the present disclosure (hereinafter, sometimes referred to as “production method of the present disclosure”), a modifier 60 is diffused and infiltrated into the rare earth magnet precursor 50 at such a “high temperature” as not to allow for coarsening of the main phase of the rare earth magnet precursor 50. Accordingly, the average particle diameter of the main phase 10 of the rare earth magnet precursor 50 and the average particle diameter of the main phase of the rare earth magnet 100 of the present disclosure are sizes substantially in the same range. Then, the average particle diameter of the main phase 10 of the rare earth magnet precursor 50 is as described in the “Rare Earth Magnet”. Incidentally, for the sake of convenience, the main phase 10 of the rare earth magnet precursor 50 may be referred to as the precursor main phase.

The grain boundary phase 20 of the rare earth magnet precursor 50 does not contain elements derived from the modifier 60, but, as with the rare earth magnet 100 of the present disclosure, the grain boundary phase 20 contains a phase whose crystal structure is indistinct, excluding the triple point 22. In addition, as with the rare earth magnet 100 of the present disclosure, the grain boundary phase 20 of the rare earth magnet precursor 50 may contain an R_{1.1}Fe₄B₄ phase as the triple point 22. Incidentally, for the sake of convenience, the main phase 10 of the rare earth magnet precursor 50 may be referred to as the precursor grain boundary phase.

Anisotropy may be imparted to the rare earth magnet precursor 50 for use in the production method of the present disclosure. For the sake of convenience, this rare earth magnet precursor 50 may be referred to as “anisotropic rare earth magnet precursor”.

For the rare earth magnet precursor 50 used in the production method of the present disclosure, a conventional method for producing a rare earth sintered magnet can be used. In general, the rare earth sintered magnet means a rare earth magnet obtained by cooling a molten metal having a composition capable of giving an R₂Fe₁₄B phase at such a rate as to reduce the size of the main phase to a micro level, thereby obtaining a magnetic powder, and subjecting a green compact of the magnetic powder to pressureless high temperature sintering. The magnetic powder may be compacted in a magnetic field (molding in a magnetic field) to impart anisotropy to the rare earth magnet after sintering (rare earth sintered magnet).

On the other hand, the nanocrystallized rare earth magnet generally means a rare earth magnet obtained by cooling a molten metal having a composition capable of giving an R₂Fe₁₄B phase at such a rate as to nanocrystallize the main phase, thereby obtaining a magnetic powder, and subjecting the magnetic powder to low-temperature pressure sintering (low-temperature hot pressing). The nanocrystallized main phase may also be obtained by heat-treating an amorphous phase. Since it is difficult to orient the nanocrystallized magnetic powder by the molding in a magnetic field, the magnetic powder is oriented by subjecting a sintered body obtained by low-temperature pressure sintering to hot plastic working. Such a magnet is referred to as a hot plastic worked rare earth magnet.

In the production method of the present disclosure, a modifier 60 is diffused and infiltrated into the rare earth magnet precursor 50 at a high temperature. The “high temperature” is a temperature at which the nanocrystallized main phase is coarsened, and therefore a rare earth magnet precursor having a nanocrystallized main phase cannot be used in the production method of the present disclosure. In addition, when a modifier is diffused and infiltrated at a “high temperature” referred to in the production method of the present disclosure into a rare earth magnet precursor having a nanocrystallized main phase, in addition to coarsening of the main phase, formation of a core/shell structure of the main phase is also inhibited. As a result, the effects of the production method of the present disclosure are not obtained.

Preparation of the rare earth magnet precursor in the production method of the present disclosure may be performed, for example, as follows, but the preparation is not limited thereto.

A molten metal represented, in terms of molar ratio, by the formula: (R²₍₁₋ₓ₎R¹ₓ)_{y}Fe_{(100-y-w-z-v)}Co_{w}B_{z}M¹ᵥ is cooled at a such a rate as to give an average particle diameter of 1 to 20 μm to the main phase (R₂Fe₁₄B phase), and a magnetic ribbon is thereby obtained. This cooling rate is, for example, from 1 to 1,000° C./s. In addition, the method for obtaining a magnetic powder at such a cooling rate includes, for example, a strip casting method, a book molding method, etc. The composition of the molten metal is fundamentally the same as the overall composition of the rare earth magnet precursor, but as for the element that may be consumed in the process of producing the rare earth magnet precursor, the overall composition can be made up in consideration of the consumption.

A magnetic powder obtained by pulverizing a magnetic ribbon obtained as above is compacted. The powder compacting may be performed in a magnetic field. The molding pressure during powder compacting may be, for example, 50 MPa or more, 100 MPa or more, 200 MPa or more, or 300 MPa or more, and may be 1000 MPa or less, 800 MPa or less, or 600 MPa or less. The magnetic field applied may be 0.1 T or more, 0.5 T or more, 1 T or more, 1.5 T or more, or 2.0 T or more, and may be 10.0 T or less, 8.0 T or less, 6.0 T or less, or 4.0 T or less. The pulverization method includes, for example, a method where the magnetic ribbon is coarsely pulverized and then further pulverized by means of a jet mill, etc. The method for coarse pulverization includes, for example, a method using a hammer mill, a method where the magnetic ribbon is embrittled by hydrogen, and a combination thereof, etc.

The thus-obtained green compact is subjected to pressureless sintering to obtain a rare earth magnet precursor. In order to sinter the green compact without applying a pressure and thereby increase the density of the sintered body, the green compact is sintered at a high temperature over a long period of time. The sintering temperature may be, for example, 900° C. or more, 950° C. or more, or 1,000° C. or more, and may be 1,100° C. or less, 1,050° C. or less, or 1,040° C. or less. The sintering time may be, for example, 1 hour or more, 2 hours or more, 3 hours or more, or 4 hours or more, and may be 24 hours or less, 18 hours or less, 12 hours or less, or 6 hours or less. In order to suppress oxidation of the green compact during sintering, the sintering atmosphere is preferably an inert gas atmosphere. The inert gas atmosphere includes a nitrogen gas atmosphere.

With respect to the main phase 10 of the rare earth magnet precursor 50, the volume fraction of the main phase 10 relative to the rare earth magnet precursor 50 can be controlled by appropriately changing, for example, the total content ratio y of R¹ and R², the content ratio z of B, or the cooling rate at the production of the rare earth magnet precursor 50.

In the rare earth magnet precursor 50, as long as the volume fraction of the main phase 10 is not excessively increased to excessively decrease the volume fraction of the grain boundary phase 20, the volume fraction of the main phase 10 is preferably higher. When the volume fraction of the main phase 10 of the rare earth magnet precursor 50 is high, the volume fraction of the main phase 10 of the rare earth magnet 100 of the present disclosure is also increased, and this contributes to enhancement of the residual magnetization.

On the other hand, if the volume fraction of the main phase 10 of the rare earth magnet precursor 50 is excessively increased and the volume fraction of the grain boundary phase 20 is excessively decreased, although not bound by theory, the modifier 60 may diffuse and infiltrate into the grain boundary phase 20, but the shell portion 14 is not formed. As a result, in the rare earth magnet 100 of the present disclosure, both the anisotropic magnetic field (coercive force) and the residual magnetization are significantly reduced.

From the viewpoint of contributing the enhancement of the residual magnetization, the volume fraction of the main phase 10 of the rare earth magnet precursor 50 may be 90.0% or more, 90.5% or more, 91.0% or more, 92.0% or more, 94.0% or more, or 95.0% or more. On the other hand, from the viewpoint of preventing the volume fraction of the main phase 10 of the rare earth magnet precursor 50 from excessively increasing, the volume fraction of the main phase 10 of the rare earth magnet precursor 50 may be 97.0% or less, 96.5% or less, or 95.9% or less.

### <Preparation of Modifier>

A modifier having a composition represented, in terms of molar ratio, by the formula: R³₍₁₋ₚ₎M²p is prepared. In the formula representing the composition of the modifier, R³, M² and p are as described in “«Rare Earth Magnet»”.

The method for preparing the modifier includes, for example, a method where a molten metal having the composition of the modifier is formed using a liquid quenching method or a strip casting method, etc. to obtain a ribbon, etc. In this method, the molten metal is quenched, and therefore segregation is less likely to occur in the modifier. In addition, the method for preparing the modifier includes, for example, a method where a molten metal having the composition of the modifier is cast in a casting mold such as book mold. In this method, a large amount of modifier is relatively easily obtained. In order to decrease the segregation of the modifier, the book mold is preferably made of a material having a high thermal conductivity. Furthermore, the casting material is preferably heat-treated for homogenization so as to suppress segregation. Moreover, the method for preparing the modifier includes a method where raw materials of the modifier are loaded into a container, the raw materials are arc-melted, and the melted product is cooled to obtain an ingot. In this method, even when the melting point of the raw material is high, the modifier can relatively easily be obtained. From the viewpoint of reducing segregation of the modifier, the ingot is preferably heat-treated for homogenization.

### <Diffusion and Infiltration>

A modifier is diffused and infiltrated into the rare earth magnet precursor at a temperature of not less than the melting point of the modifier and from 750 to 1,000° C.

As illustrated in FIG. 2A and FIG. 2B, when the temperature is not less than the melting point of the modifier 60, the melt 62 of the modifier 60 diffuses and infiltrates into the grain boundary phase 20 of the rare earth magnet precursor 50. Then, as illustrated in FIG. 3A and FIG. 3B, in order for R₁ in the vicinity of the surface layer part of the main phase 10 of the rare earth magnet precursor 50 to be replaced by R³ of the melt 62 of the modifier 60 and form a predetermined shell portion 14, the modifier 60 is diffused and infiltrated into the rare earth magnet precursor 50 at 750 to 1,000° C. In the case where the melting point of the modifier 60 is 750° C. or more, the diffusion and infiltration temperature may be a temperature not less than the melting point of the modifier 60.

In the case where the melting point of the modifier 60 is less than 750° C., when the modifier 60 is diffused and infiltrated into the rare earth magnet precursor 50 at a temperature of not less than the melting point of the modifier 60 and less than 750° C., the melt 62 of the modifier 60 only diffuses and infiltrates into the grain boundary phase 20, and a shell portion 14 having a sufficient Nd concentration is not formed. For example, in the case of using a Nd_{0.7}Cu_{0.3} alloy as the modifier 60, the melting point of the Nd_{0.7}Cu_{0.3} alloy is 520° C. When the diffusion and infiltration temperature is 650° C., the melt 62 of the Nd_{0.7}Cu_{0.3} alloy diffuses and infiltrates into the grain boundary phase 20 but fails in forming a shell portion 14.

As long as the main phase 10 of the rare earth magnet precursor 50 is not coarsened during diffusion and infiltration of the modifier 60, the diffusion and infiltration temperature is preferably higher for forming a predetermined shell portion 14. When the diffusion and infiltration temperature is 1,000° C. or less, coarsening of the main phase 10 of the rare earth magnet precursor 50 can be suppressed. For this reason, the modifier 60 is diffused and infiltrated at a temperature of not less than the melting point of the modifier 60 and from 750 to 1,000° C. As long as the temperature is not less than the melting point of the modifier 60, the lower limit of the diffusion and infiltration temperature may be 800° C., 850° C., or 900° C. In addition, as long as the temperature is not less than the melting point of the modifier, the upper limit of the diffusion and infiltration temperature may be 975° C. or 950° C.

At the time of diffusion and infiltration of the modifier 60, relative to 100 parts by mol of the rare earth magnet precursor 50, from 0.1 to 15.0 parts by mol of the modifier 60 is brought into contact with the rare earth magnet precursor 50. When 0.1 parts by mol or more, 2.0 parts by mol or more, 3.0 parts by mol or more, 3.6 parts by mol or more, or 4.0 parts by mol or more of the modifier 60 is diffused and infiltrated by bringing it into contact with the rare earth magnet precursor 50, formation of the shell portion 14 can be substantially recognized. On the other hand, when 15.0 parts by mol or less, 14.0 parts by mol or less, 12.0 parts by mol or less, 10.4 parts by mol or less, 10.0 parts by mol or less, 8.0 parts by mol or less, or 6.0 parts by mol or less of the modifier 60 is diffused and infiltrated by bringing it into contact with the rare earth magnet precursor 50, the amount of M² remaining in the grain boundary phase 20 can be decreased, and the reduction in the residual magnetization can be suppressed.

After the ratio of the modifier 60 brought into contact with the rare earth magnet precursor 50 is set as above, the composition of the modifier 60 is appropriately determined to set the above-described b and b/a to fall in predetermined ranges. For this purpose, when the diffusion and infiltration ratio of R³ of the modifier 60 relative to the total of the rare earth magnet precursor 50 and the modifier 60 (100 parts by mol+q parts by mol) is 3.7 parts by mol or more, predetermined b and b/a are obtained. From this viewpoint, the diffusion and infiltration ratio of R³ of the modifier 60 may be 3.8 parts by mol or more, 4.0 parts by mol or more, 4.6 parts by mol or more, 5.2 parts by mol or more, or 5.8 parts by mol or more. On the other hand, when the diffusion and infiltration ratio of R³ of the modifier 60 is 10.0 parts by mol or less, predetermined b and b/a are obtained, and the enhancement of the anisotropic magnetic field (coercive force) and residual magnetization is saturated, nevertheless, it is less likely that the modifier 60 is unnecessarily diffused and infiltrated. From this viewpoint, the diffusion and infiltration ratio of R³ of the modifier 60 may be 9.0 parts by mol or less, 8.5 parts by mol or less, 8.0 parts by mol or less, 7.8 parts by mol or less, 7.5 parts by mol or less, 7.0 parts by mol or less, or 6.5 parts by mol or less.

The above-described state where “predetermined band b/a are obtained, and the enhancement of the anisotropic magnetic field (coercive force) and residual magnetization is saturated” is described. Although not bound by theory, even when R³ of the modifier 60 is excessively diffused and infiltrated into the rare earth magnet precursor 50, the ratio at which R¹ in the vicinity of the surface layer part of the main phase 10 of the rare earth magnet precursor 50 is replaced by R³ of the modifier 60 is limited. Therefore, it is considered that after b and b/a have reached predetermined ranges in the shell portion 14, redundant R³ remains in the grain boundary phase 20 and the enhancement of the anisotropic magnetic field (coercive force) and residual magnetization is saturated.

Incidentally, when the diffusion and infiltration ratio of R³ of the modifier 60 relative to the total of the rare earth magnet precursor 50 and the modifier 60 (100 parts by mol+q parts by mol) is expressed using p and q in the overall composition of the rare earth magnet 100 of the present disclosure, the diffusion and infiltration ratio is represented by {(1−p)×q}/(100+q).

### <Cooling Rate After Diffusion and Infiltration>

After the modifier 60 is diffused and infiltrated into the rare earth magnet precursor 50, the rare earth magnet precursor 50 and the modifier 60 are cooled to obtain the rare earth magnet 100 of the present disclosure. As described above, when the modifier 60 is diffused and infiltrated into the grain boundary phase 20, the vicinity of the surface layer of the main phase 10 melts (see, FIG. 2A and FIG. 2B), and a shell portion 14 is formed by cooling it (see, FIG. 3A and FIG. 3B).

Although not bound by theory, as long as the productivity is not inhibited, when the cooling rate is slow, the interface between the shell portion 14 and the grain boundary phase 20 is likely to form a facet surface. This facet surface is considered to enhance the coercive force.

From the viewpoint of enhancing the coercive force, the cooling rate may be 10° C./min or less, 7° C./min or less, 4° C./min or less, or 1° C./min or less. On the other hand, from the viewpoint of not inhibiting the productivity, the cooling rate may be 0.1° C./min or more, 0.2° C./min or more, 0.3° C./min or more, 0.5° C./min or more, or 0.6° C./min or more. Incidentally, the cooling rate described here is a cooling rate up to 500° C.

### <Diffusion and Infiltration of Fe-Containing Modifier>

As described above, when a Fe-containing modifier 60 is used (see FIG. 3B), the region in which an R_{1.1}Fe₄B₄ phase is formed as the triplet point 22 at the time of using a modifier 60 free from Fe (see, FIG. 3A) also works out to part of the main phase 10 (R₂Fe₁₄B phase), and the residual magnetization is further enhanced.

The content of B is larger in the R_{1.1}Fe₄B₄ phase than in the R₂Fe₁₄B phase (main phase 10). Therefore, in the case of using a Fe-containing modifier, it is preferable to increase the content of B of the rare earth magnet precursor 50 and thereby facilitate the formation of the R_{1.1}Fe₄B₄ phase as the triple point 22. This is described by referring to the drawing. FIG. 4 is a schematic diagram illustrating a composition range where the R_{1.1}Fe₄B₄ phase is likely to be formed. In FIG. 4, the shaded area is the composition range where the R_{1.1}Fe₄B₄ phase is likely to be formed, and this is the side where the ratio of B is higher than the R₂Fe₁₄B phase. Specifically, z in the above-described composition formula of the rare earth magnet precursor is set to be 5.6 or more. From this viewpoint, z may be 5.8 or more, 6.0 or more, 6.2 or more, 6.4 or more, 6.6 or more, 6.8 or more, or 7.0 or more.

The rare earth magnet precursor 50 is produced by cooling the molten metal having the composition of the rare earth magnet precursor 50. When z is set to the range above, the R_{1.1}Fe₄B₄ phase is likely to be formed and furthermore, when the cooling rate of the molten metal is smaller, the R_{1.1}Fe₄B₄ phase is readily formed. These teach that the volume fraction of the R_{1.1}Fe₄B₄ phase relative to the rare earth magnet precursor 50 can be controlled by the value of z and the molten metal cooling rate.

The volume fraction of the R_{1.1}Fe₄B₄ phase relative to the rare earth magnet precursor 50 may be 0 vol % or more, 0.1 vol % or more, 0.4 vol % or more, 0.8 vol % or more, 1.4 vol % or more, 2.0 vol % or more, or 5.0 vol % or more, and may be 30.0 vol % or less, 25.0 vol % or less, 20.0 vol % or less, 15.0 vol % or less, 10.0 vol % or less, or 8.0 vol % or less.

As described above, the composition of the modifier 60 is represented, in terms of molar ratio, by the formula: R³₍₁₋ₚ₎M²ₚ (wherein R³ is one or more elements selected from the group consisting of Nd, Pr, Gd, Tb, Dy, and Ho, M² is composed of a transition metal element which is other than a rare earth element and can be alloyed with R³, and unavoidable impurity elements, and 0.05≤p≤0.40). The composition of the Fe-containing modifier 60 is represented as follows using Fe and M³ in place of M².

The composition of the modifier 60 is represented, in terms of molar ratio, by the formula: R³₍₁₋ₛ₋ₜ₎FeₛM³ₜ. M³ is composed of a transition metal element which is other than a rare earth element and can be alloyed with R³ and Fe, and unavoidable impurity elements, and 0.05≤s≤0.30, 0≤t≤0.20 and 0.05≤s+t≤0.40 are satisfied.

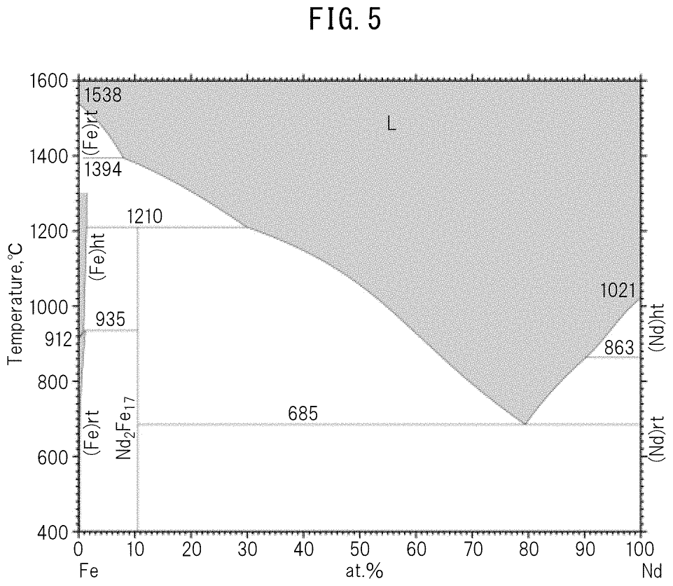

The molar ratio s of Fe in the modifier 60 is described using a Fe—Nd phase diagram assuming the modifier 60 is, for example, a Nd—Fe alloy (the case where R³ is Nd and M³ is not contained (t=0)). FIG. 5 is a Fe—Nd phase diagram. The source is Binary Alloy Phase Diagrams, II Ed., Ed. T. B. Massalski, 1990, 2, 1732-1735. As described above, when the diffusion and infiltration temperature is 1,000° C. or less, coarsening of the main phase 10 of the rare earth magnet precursor 50 can be avoided from occurring during diffusion and infiltration of the modifier 60. For this reason, the melting point of the Nd—Fe alloy is preferably 950° C. or less. It is understood from FIG. 5 that the composition range of the Nd—Fe alloy in which the melting point becomes 950° C. or less is from Nd_{0.58}Fe_{0.42} to Nd_{0.95}Fe_{0.05} (0.05≤s≤0.42). Furthermore, as described above, when 3.7 parts by mol or more of R³ (Nd) relative to the total of the rare earth magnet precursor 50 and the modifier 60 is diffused and infiltrated, the desired shell portion 14 is likely to be obtained. Accordingly, within the range above, the composition range of the Nd—Fe alloy in which 3.7 parts by mol or more of R³ (Nd) is diffused and infiltrated is from Nd_{0.7}Fe_{0.3} to Nd_{0.95}Fe_{0.05} (0.05≤s≤0.30).

The description above is based on the assumption that the modifier 60 is a Nd—Fe alloy (the case where R³ is Nd and M³ is not contained (t=0)), but since R³ is one or more elements selected from the group consisting of Nd, Pr, Gd, Tb, Dy, and Ho, the value of s can be changed from the range above. In addition, the melting point of the modifier 60 can change depending on M², and therefore the value of s can be changed from the range above. Accordingly, when the range that the value of s can take is verified experimentally, s may be 0.05 or more, 0.10 or more, or 0.15 or more, and may be 0.30 or less, 0.25 or less, or 0.20 or less.

When s is in the range above, the modifier 60 can be diffused and infiltrate at a temperature where the main phase 10 of the rare earth magnet precursor 50 is not coarsened, but by optionally containing M³, the melting point of the modifier can be reduced. From this viewpoint, t may be 0 or more, 0.05 or more, or 0.10 or more. On the other hand, when t is 0.20 or less, the component does not contribute to forming of the R₂Fe₁₄B phase (main phase 10) from the R_{1.1}Fe₄B₄ phase and can be prevented from remaining in the grain boundary phase 20 to cause a reduction in the residual magnetization of the rare earth magnet 100 of the present disclosure. From this viewpoint, t may be 0.18 or less, 0.16 or less, or 0.14 or less.

R³₍₁₋ₛ₋ₜ₎FeₛM³ₜ is a formula where M² of R³₍₁₋ₚ₎M²ₚ is divided into Fe and M³, and therefore, the range of (s+t) is the same as the range of p. That is, 0.05≤s+t≤0.40 is satisfied. Incidentally, s and t satisfy 0.05≤s≤0.30 and 0≤t≤0.20, respectively, and at the same time, satisfy 0.05≤s+t≤0.40. Accordingly, for example, when t is 0.20, the upper limit of s is 0.20.

### <Heat Treatment>

After diffusing and infiltrating the modifier 60 into the rare earth magnet precursor 50, the precursor may be cooled and directly used as the rare earth magnet 100 of the present disclosure, or the rare earth magnet after cooling may be further heat-treated and used as the rare earth magnet 100 of the present disclosure. Although not bound by theory, it is believed that due to this heat treatment, part of the grain boundary phase 20 after diffusing and infiltrating the modifier 60 is melted without altering (without melting) the structure of the main phase 10 and the melt is solidified to evenly cover the main phase 10, contributing the enhancement of the coercive force.

For enjoying the effect of enhancing the coercive force, the heat treatment temperature is preferably 450° C. or more, more preferably 475° C. or more, still more preferably 500° C. or more. On the other hand, for avoiding alteration of the structure of the main phase 10, the heat treatment temperature is preferably 600° C. or less, more preferably 575° C. or less, still more preferably 550° C. or less.

For avoiding oxidation of the rare earth magnet 100 of the present disclosure, the heat treatment is preferably performed in an inert gas atmosphere. The inert gas atmosphere includes a nitrogen gas atmosphere.

Incidentally, in the present description, the hereinbefore-described heat treatment after diffusion and infiltration is sometimes referred to as “heat treatment for optimization”.

### EXAMPLES

The rare earth magnet of the present disclosure and the production method thereof are described more specifically below by referring to Examples and Comparative Examples. Note that the rare earth magnet of the present disclosure and the production method thereof are not limited to the conditions employed in the following Examples.

### Examples

### <Preparation of Samples of Examples 1 to 10 and Comparative Examples 1 to 5>

The following samples were prepared mainly for verifying the effect of the diffusion and infiltration temperature.

A strip cast material having an overall composition represented, in terms of molar ratio, by Nd_{7.6}Ce_{5.4}La_{1.7}Fe_{bal}B_{6.4}Cu_{0.1}Ga_{0.3} was pulverized by hydrogenation and then further pulverized using a jet mill to obtain a magnetic powder. The magnetic powder was molded in a magnetic field of 2 T to obtain a green compact. At this time, the molding pressure was 200 MPa. This green compact was subjected to pressureless sintering at 1,040° C. over 4 hours to obtain a sintered magnet.

The resulting sintered magnet was cutout to 4 mm×4 mm×2 mm (t) and used as a rare earth magnet precursor, and a modifier having the composition shown in Table 1 was diffused and infiltrated into the rare earth magnet precursor. The diffusion and infiltration time was 165 minutes. The rare earth magnet precursor after the diffusion and infiltration of the modifier was then cooled to 500° C. at a rate of 10° C./min and further furnace-cooled.

### <Evaluation of Samples of Examples 1 to 10 and Comparative Examples 1 to 5>

The magnetic properties of each of the obtained samples were measured at room temperature by using Vibrating Sample Magnetometer (VSM). In addition, as for the sample of Example 9, area analysis was performed using SEM-EDX.

The results are shown in Table 1. In Table 1, the average particle diameter of the main phase of the rare earth magnet precursor was determined by the method described in the paragraph of “«Rare Earth Magnet»”. Unless otherwise indicted, the same holds true for Tables other than Table 1.

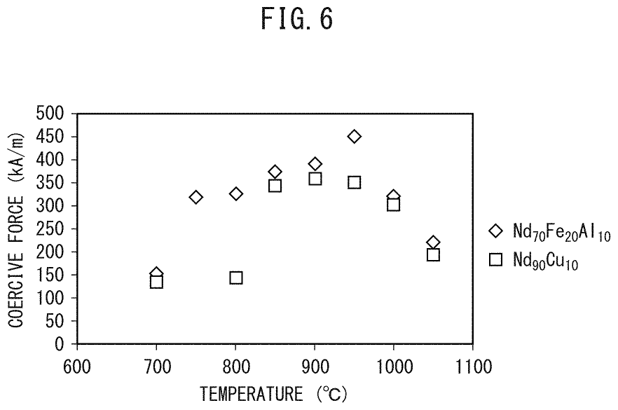

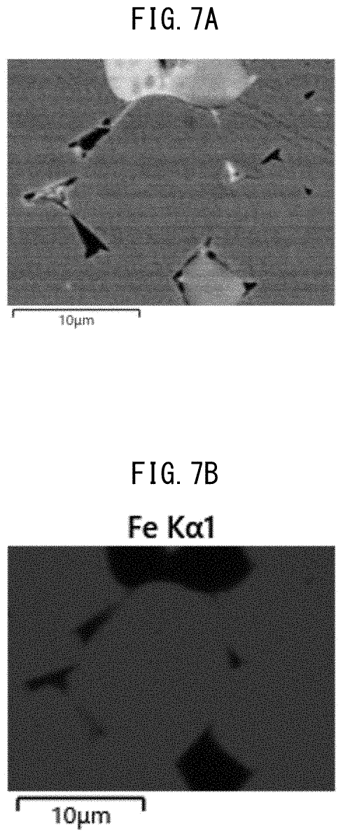

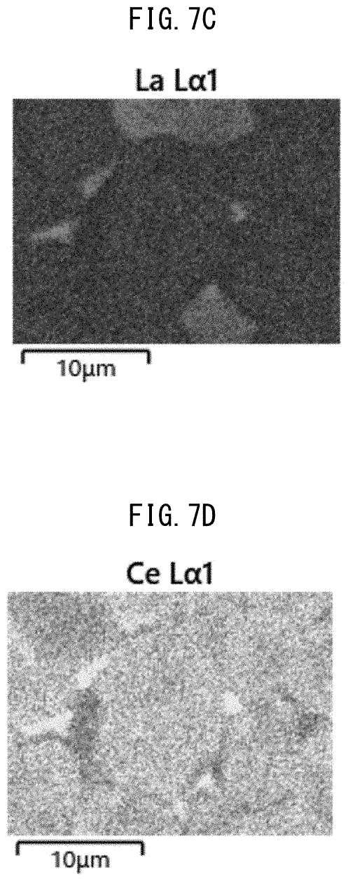

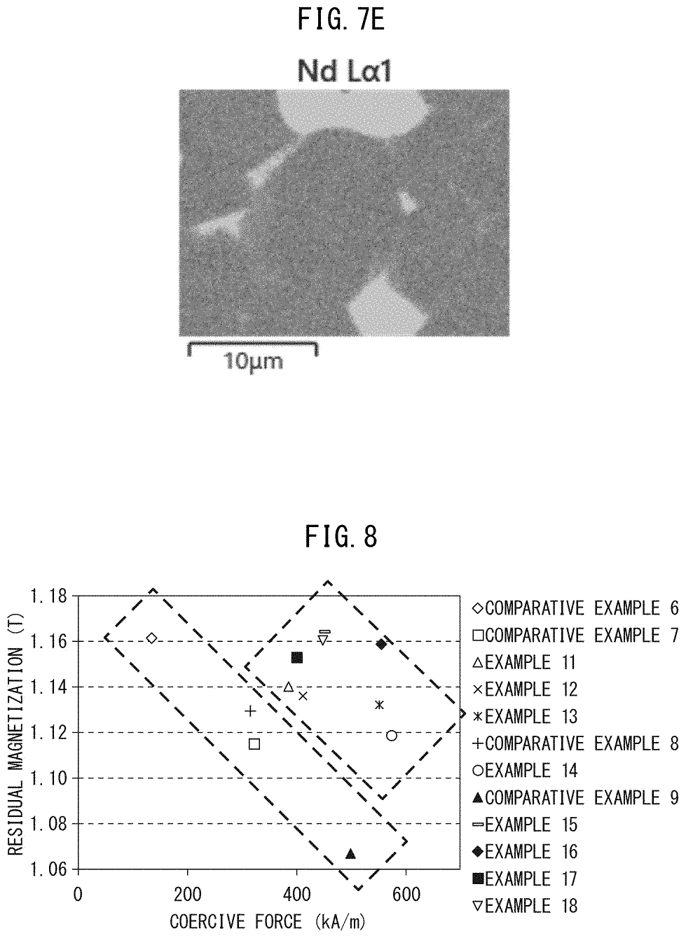

FIG. 6 is a graph illustrating the relationship between the diffusion/infiltration temperature and the coercive force with respect to the samples of Examples 1 to 10 and Comparative Examples 1 to 5. FIG. 7A is a diagram illustrating the results when the sample of Example 9 is observed by SEM. FIG. 7B is a diagram illustrating the results when area analysis of Fe is performed using SEM-EDX with respect to the region shown in FIG. 7A. FIG. 7C is a diagram illustrating the results when area analysis of La is performed using SEM-EDX with respect to the region shown in FIG. 7A. FIG. 7D is a diagram illustrating the results when area analysis of Ce is performed using SEM-EDX with respect to the region shown in FIG. 7A. FIG. 7E is a diagram illustrating the results when area analysis of Nd is performed using SEM-EDX with respect to the region shown in FIG. 7A. In FIGS. 7B to 7E, the bright field indicates that the concentration of the area-analyzed element is high.

TABLE 1

| | Rare Earth Magnet Precursor | | | | | | |
|---|---|---|---|---|---|---|---|
| | | | | Average | | | |
| | | | Volume | Particle | Volume | | |
| | | | Fraction | Diameter | Fraction | Modifier | |
| | | | of Main | of Main | of T2 | | Melting |
| | | | Phase | Phase | Phase | Composition | Point |
| | Composition (at %) | Type | (%) | (μm) | (%) | (molar ratio) | (° C.) |
| Comparative | Nd7.6Ce5.4La1.7FebalB6.4Cu0.1Ga0.3 | sintered | 90.5 | 6.5 | 1.4 | Nd0.70Fe0.20Al0.10 | 718 |
| Example 1 | | magnet | | | | | |
| Example 1 | Nd7.6Ce5.4La1.7FebalB6.4Cu0.1Ga0.3 | sintered | 90.5 | 6.5 | 1.4 | Nd0.70Fe0.20Al0.10 | 718 |
| | | magnet | | | | | |
| Example 2 | Nd7.6Ce5.4La1.7FebalB6.4Cu0.1Ga0.3 | sintered | 90.5 | 6.5 | 1.4 | Nd0.70Fe0.20Al0.10 | 718 |
| | | magnet | | | | | |
| Example 3 | Nd7.6Ce5.4La1.7FebalB6.4Cu0.1Ga0.3 | sintered | 90.5 | 6.5 | 1.4 | Nd0.70Fe0.20Al0.10 | 718 |
| | | magnet | | | | | |
| Example 4 | Nd7.6Ce5.4La1.7FebalB6.4Cu0.1Ga0.3 | sintered | 90.5 | 6.5 | 1.4 | Nd0.70Fe0.20Al0.10 | 718 |
| | | magnet | | | | | |
| Example 5 | Nd7.6Ce5.4La1.7FebalB6.4Cu0.1Ga0.3 | sintered | 90.5 | 6.5 | 1.4 | Nd0.70Fe0.20Al0.10 | 718 |
| | | magnet | | | | | |
| Example 6 | Nd7.6Ce5.4La1.7FebalB6.4Cu0.1Ga0.3 | sintered | 90.5 | 6.5 | 1.4 | Nd0.70Fe0.20Al0.10 | 718 |
| | | magnet | | | | | |
| Comparative | Nd7.6Ce5.4La1.7FebalB6.4Cu0.1Ga0.3 | sintered | 90.5 | 6.5 | 1.4 | Nd0.70Fe0.20Al0.10 | 718 |
| Example 2 | | magnet | | | | | |
| Comparative | Nd7.6Ce5.4La1.7FebalB6.4Cu0.1Ga0.3 | sintered | 90.5 | 6.5 | 1.4 | Nd0.90Cu0.10 | 848 |
| Example 3 | | magnet | | | | | |
| Comparative | Nd7.6Ce5.4La1.7FebalB6.4Cu0.1Ga0.3 | sintered | 90.5 | 6.5 | 1.4 | Nd0.90Cu0.10 | 848 |
| Example 4 | | magnet | | | | | |
| Example 7 | Nd7.6Ce5.4La1.7FebalB6.4Cu0.1Ga0.3 | sintered | 90.5 | 6.5 | 1.4 | Nd0.90Cu0.10 | 848 |
| | | magnet | | | | | |
| Example 8 | Nd7.6Ce5.4La1.7FebalB6.4Cu0.1Ga0.3 | sintered | 90.5 | 6.5 | 1.4 | Nd0.90Cu0.10 | 848 |
| | | magnet | | | | | |
| Example 9 | Nd7.6Ce5.4La1.7FebalB6.4Cu0.1Ga0.3 | sintered | 90.5 | 6.5 | 1.4 | Nd0.90Cu0.10 | 848 |
| | | magnet | | | | | |
| Example 10 | Nd7.6Ce5.4La1.7FebalB6.4Cu0.1Ga0.3 | sintered | 90.5 | 6.5 | 1.4 | Nd0.90Cu0.10 | 848 |
| | | magnet | | | | | |
| Comparative | Nd7.6Ce5.4La1.7FebalB6.4Cu0.1Ga0.3 | sintered | 90.5 | 6.5 | 1.4 | Nd0.90Cu0.10 | 848 |
| Example 5 | | magnet | | | | | |

| | | | | | | Heat | | |
|---|---|---|---|---|---|---|---|---|
| | Diffusion and Infiltration | | | | | Treatment | | |
| | Diffusion | Diffusion | R3 Diffusion | Diffusion | | Tempera- | | Residual |
| | Infiltration | Infiltration | Infiltration | Infiltration | | ture for | Coercive | Magnet- |
| | Ratio | Ratio | Ratio | Temperature | Cooling Rate | Optimization | Force | ization |
| | (mass ratio) | (molar ratio) | (molar ratio) | (° C.) | (° C./min) | (° C.) | (kA/m) | (T) |
| Comparative | 10 | 5.7 | 3.8 | 700 | 10 | — | 151.2 | 1.10 |
| Example 1 | | | | | | | | |
| Example 1 | 10 | 5.7 | 3.8 | 750 | 10 | — | 318.3 | 1.13 |
| Example 2 | 10 | 5.7 | 3.8 | 800 | 10 | — | 326.3 | 1.13 |
| Example 3 | 10 | 5.7 | 3.8 | 850 | 10 | — | 374.0 | 1.16 |
| Example 4 | 10 | 5.7 | 3.8 | 900 | 10 | — | 389.9 | 1.15 |
| Example 5 | 10 | 5.7 | 3.8 | 950 | 10 | — | 450.3 | 1.15 |
| Example 6 | 10 | 5.7 | 3.8 | 1000 | 10 | — | 318.3 | 1.16 |
| Comparative | 10 | 5.7 | 3.8 | 1050 | 10 | — | 221.5 | 1.11 |
| Example 2 | | | | | | | | |
| Comparative | 10 | 4.8 | 4.1 | 700 | 10 | — | 135.3 | 1.10 |
| Example 3 | | | | | | | | |
| Comparative | 10 | 4.8 | 4.1 | 800 | 10 | — | 143.2 | 1.11 |
| Example 4 | | | | | | | | |
| Example 7 | 10 | 4.8 | 4.1 | 850 | 10 | — | 342.2 | 1.13 |
| Example 8 | 10 | 4.8 | 4.1 | 900 | 10 | — | 358.1 | 1.13 |
| Example 9 | 10 | 4.8 | 4.1 | 950 | 10 | — | 350.1 | 1.14 |
| Example 10 | 10 | 4.8 | 4.1 | 1000 | 10 | — | 302.4 | 1.14 |
| Comparative | 10 | 4.8 | 4.1 | 1050 | 10 | — | 193.5 | 1.12 |
| Example 5 | | | | | | | | |

Note 1)
T2 Phase means R1.1Fe4B4 phase.
Note 2)
“Diffusion Infiltration Ratio (mass ratio)” means parts by mass (mass ratio) of modifier relative to 100 parts by mass of rare earth magnet precursor.
Note 3)
“Diffusion Infiltration Ratio (molar ratio)” means parts by mol (molar ratio) of modifier relative to 100 parts by mol of rare earth magnet precursor.
Note 4)
“R3 Diffusion Infiltration Ratio” means parts by mol (molar ratio) of R3 diffused and infiltrated relative to the total (100 parts by mol + q parts by mol) of rare earth magnet precursor and modifier when q parts by mol of modifier is diffused and infiltrated into 100 parts by mol of rare earth magnet precursor.
Note 5)
“Cooling Rate” means a cooling rate up to 500° C.
Note 6)
“—” in the column of “Heat Treatment Temperature for Optimization” means that heat treatment for optimization is not performed.

It could be confirmed from Table 1 and FIG. 6 that the samples of Examples 1 to 10 are excellent in both the coercive force and the residual magnetization. This is considered to occur because a desired shell portion was formed by the diffusion and infiltration of a modifier at a temperature of not less than the melting point of the modifier and from 750 to 1,000° C. Incidentally, from FIG. 7C (results of area analysis of Ce) and FIG. 7D (results of area analysis of Nd), it is recognized that part of Ce is replaced by Nd in the shell portion and the Nd concentration is slightly higher in the shell portion than in the core portion. However, the results of area analysis using SEM-EDX do not necessarily clearly show that the concentration of the rare earth element (Nd) other than the light rare earth element is significantly high in the shell portion. Then, as described later, this was verified by again performing area analysis by means of Cs-STEM-EDX on the samples of Examples 22, 37, 44, 54 and 55 and Comparative Example 14.

On the other hand, in the samples of Comparative Examples 1 and 3 where the diffusion and infiltration temperature is more than the melting point of the modifier, the modifier is diffused and infiltrated into the grain boundary phase. However, the diffusion and infiltration temperature is less than 750° C., and therefore the residual magnetization is low. This is considered to occur because a desired shell portion is not formed. Furthermore, in the samples of Comparative Examples 2 and 5 where the diffusion and infiltration temperature exceeds 1,000° C., both the coercive force and the residual magnetization are reduced. This is considered to occur due to coarsening of the main phase. Furthermore, in the sample of Comparative Example 3 where the diffusion and infiltration temperature is not more than the melting point of the modifier, modification is not effected, and the coercive force is extremely low.

### <Preparation of Samples of Examples 11 to 18 and Comparative Examples 6 to 9>

The following samples were prepared mainly for confirming the effect of the composition of the modifier.

A strip cast material having an overall composition represented, in terms of molar ratio, by Nd_{7.6}Ce_{5.4}La_{1.7}Fe_{bal}B_{6.4}Cu_{0.1}Ga_{0.3} was pulverized by hydrogenation and then further pulverized using a jet mill to obtain a magnetic powder. The magnetic powder was molded in a magnetic field of 2 T to obtain a green compact. At this time, the molding pressure was 200 MPa. This green compact was subjected to pressureless sintering at 1,040° C. over 4 hours to obtain a sintered magnet.

The resulting sintered magnet was cutout to 4 mm×4 mm×2 mm (t) and used as a rare earth magnet precursor, and a modifier having the composition shown in Table 2 was diffused and infiltrated into the rare earth magnet precursor. The diffusion and infiltration time was 165 minutes. The rare earth magnet precursor after the diffusion and infiltration of the modifier was then cooled to 500° C. at a rate of 1° C./min and further furnace-cooled.

### <Evaluation of Samples of Examples 11 to 18 and Comparative Examples 6 to 9>

The magnetic properties of each of the obtained samples were measured at room temperature by using Vibrating Sample Magnetometer (VSM).

The results are shown in Table 2. In Table 2, Di indicates didymium. In addition, FIG. 8 is a graph illustrating the relationship between the coercive force and the residual magnetization with respect to the samples of Examples 11 to 18 and Comparative Examples 6 to 9.

TABLE 2

| | Rare Earth Magnet Precursor | | | | | | |
|---|---|---|---|---|---|---|---|
| | | | | Average | | | |
| | | | Volume | Particle | Volume | | |
| | | | Fraction | Diameter | Fraction | Modifier | |
| | | | of Main | of Main | of T2 | | Melting |
| | | | Phase | Phase | Phase | Composition | Point |
| | Composition (at %) | Type | (%) | (μm) | (%) | (molar ratio) | (° C.) |
| Comparative | Nd7.6Ce5.4La1.7FebalB6.4Cu0.1Ga0.3 | sintered | 90.5 | 6.5 | 1.4 | not diffused and infiltrated | |
| Example 6 | | magnet | | | | | |
| Comparative | Nd7.6Ce5.4La1.7FebalB6.4Cu0.1Ga0.3 | sintered | 90.5 | 6.5 | 1.4 | Nd0.70Cu0.30 | 520 |
| Example 7 | | magnet | | | | | |
| Example 11 | Nd7.6Ce5.4La1.7FebalB6.4Cu0.1Ga0.3 | sintered | 90.5 | 6.5 | 1.4 | Nd0.80Cu0.20 | 692 |
| | | magnet | | | | | |
| Example 12 | Nd7.6Ce5.4La1.7FebalB6.4Cu0.1Ga0.3 | sintered | 90.5 | 6.5 | 1.4 | Nd0.90Cu0.10 | 848 |
| | | magnet | | | | | |
| Example 13 | Nd7.6Ce5.4La1.7FebalB6.4Cu0.1Ga0.3 | sintered | 90.5 | 6.5 | 1.4 | Nd0.85Al0.15 | 635 |
| | | magnet | | | | | |
| Comparative | Nd7.6Ce5.4La1.7FebalB6.4Cu0.1Ga0.3 | sintered | 90.5 | 6.5 | 1.4 | Di0.70Cu0.30 | 508 |
| Example 8 | | magnet | | | | | |
| Example 14 | Nd7.6Ce5.4La1.7FebalB6.4Cu0.1Ga0.3 | sintered | 90.5 | 6.5 | 1.4 | Di0.85Al0.15 | 651 |
| | | magnet | | | | | |
| Comparative | Nd7.6Ce5.4La1.7FebalB6.4Cu0.1Ga0.3 | sintered | 90.5 | 6.5 | 1.4 | Nd0.51Cu0.15Al0.34 | 664 |
| Example 9 | | magnet | | | | | |
| Example 15 | Nd7.6Ce5.4La1.7FebalB6.4Cu0.1Ga0.3 | sintered | 90.5 | 6.5 | 1.4 | Nd0.70Fe0.20Al0.10 | 718 |
| | | magnet | | | | | |
| Example 16 | Nd7.6Ce5.4La1.7FebalB6.4Cu0.1Ga0.3 | sintered | 90.5 | 6.5 | 1.4 | Nd0.80Fe0.10Al0.10 | 660 |
| | | magnet | | | | | |
| Example 17 | Nd7.6Ce5.4La1.7FebalB6.4Cu0.1Ga0.3 | sintered | 90.5 | 6.5 | 1.4 | Nd0.80Fe0.20 | 685 |
| | | magnet | | | | | |
| Example 18 | Nd7.6Ce5.4La1.7FebalB6.4Cu0.1Ga0.3 | sintered | 90.5 | 6.5 | 1.4 | Nd0.90Fe0.10 | 848 |
| | | magnet | | | | | |

| | | | | | | Heat | | |
|---|---|---|---|---|---|---|---|---|
| | Diffusion and Infiltration | | | | | Treatment | | |
| | Diffusion | Diffusion | R3 Diffusion | Diffusion | | Tempera- | | Residual |
| | Infiltration | Infiltration | Infiltration | Infiltration | | ture for | Coercive | Magnet- |
| | Ratio | Ratio | Ratio | Temperature | Cooling Rate | Optimization | Force | ization |
| | (mass ratio) | (molar ratio) | (molar ratio) | (° C.) | (° C./min) | (° C.) | (kA/m) | (T) |
| Comparative | not diffused and infiltrated | | | | | — | 134.3 | 1.16 |
| Example 6 | | | | | | | | |
| Comparative | 10 | 5.5 | 3.6 | 950 | 1 | — | 322.1 | 1.12 |
| Example 7 | | | | | | | | |
| Example 11 | 10 | 5.1 | 3.9 | 950 | 1 | — | 384.0 | 1.14 |
| Example 12 | 10 | 4.8 | 4.1 | 950 | 1 | — | 411.8 | 1.14 |
| Example 13 | 10 | 5.2 | 4.2 | 950 | 1 | — | 551.1 | 1.13 |
| Comparative | 10 | 5.5 | 3.6 | 950 | 1 | — | 314.9 | 1.13 |
| Example 8 | | | | | | | | |
| Example 14 | 10 | 5.2 | 4.2 | 950 | 1 | — | 572.3 | 1.12 |
| Comparative | 10 | 7.1 | 3.4 | 950 | 1 | — | 498.6 | 1.07 |
| Example 9 | | | | | | | | |
| Example 15 | 10 | 5.7 | 3.8 | 950 | 1 | — | 450.3 | 1.16 |
| Example 16 | 10 | 5.3 | 4 | 950 | 1 | — | 554.2 | 1.16 |
| Example 17 | 10 | 5.1 | 3.9 | 950 | 1 | — | 399.4 | 1.15 |
| Example 18 | 10 | 4.8 | 4.2 | 950 | 1 | — | 447.5 | 1.16 |

Note 1)
T2 Phase means R1.1Fe4B4 phase.
Note 2)
“Diffusion Infiltration Ratio (mass ratio)” means parts by mass (mass ratio) of modifier relative to 100 parts by mass of rare earth magnet precursor.
Note 3)
“Diffusion Infiltration Ratio (molar ratio)” means parts by mol (molar ratio) of modifier relative to 100 parts by mol of rare earth magnet precursor.
Note 4)
“R3 Diffusion Infiltration Ratio” means parts by mol (molar ratio) of R3 diffused and infiltrated relative to the total (100 parts by mol + q parts by mol) of rare earth magnet precursor and modifier when q parts by mol of modifier is diffused and infiltrated into 100 parts by mol of rare earth magnet precursor.
Note 5)
“Cooling Rate” means a cooling rate up to 500° C.
Note 6)
“—” in the column of “Heat Treatment Temperature for Optimization” means that heat treatment for optimization is not performed.

It could be confirmed from Table 2 and FIG. 8 that the samples of Examples 11 to 18 are excellent in both the coercive force and the residual magnetization. This is considered to occur because R³ is diffused and infiltrated at not less than the predetermined ratio relative to the total of the rare earth magnet precursor and the modifier. On the other hand, in the samples of Comparative Examples 6 to 9, R³ is diffused and infiltrated at less than the predetermined ratio relative to the total of the rare earth magnet precursor and the modifier and therefore, at least one of the coercive force and the residual magnetization is low. Furthermore, as in the sample of Comparative Example 9, when the content ratio of R³ in the modifier is low (i.e., the content ratio of M² in the modifier is high), a large amount of M² (a transition metal element other than the rare earth element) remains in the grain boundary phase after the diffusion and infiltration of the modifier and therefore, even if the coercive force is enhanced, the residual magnetization is extremely reduced.

### <Preparation of Samples of Examples 19 and 20 and Comparative Example 10>

The following samples were prepared mainly for verifying the effect of the content ratio of B of the rare earth magnet precursor in the case of using a Fe-containing modifier.

A strip cast material having the overall composition shown, in terms of molar ratio, in Table 3 was pulverized by hydrogenation and then further pulverized using a jet mill to obtain a magnetic powder. The magnetic powder was molded in a magnetic field of 2 T to obtain a green compact. At this time, the molding pressure was 400 MPa. This green compact was subjected to pressureless sintering at 1,040° C. over 4 hours to obtain a sintered magnet.

The resulting sintered magnet was cutout to 4 mm×4 mm×2 mm (t) and used as a rare earth magnet precursor, and a modifier having the composition shown in Table 3 was diffused and infiltrated into the rare earth magnet precursor. The diffusion and infiltration time was 165 minutes. The rare earth magnet precursor after the diffusion and infiltration of the modifier was then cooled to 500° C. at a rate of 1° C./min and further furnace-cooled.

### <Evaluation of Samples of Examples 19 and 20 and Comparative Example 10>

The magnetic properties of each of the obtained samples were measured at room temperature by using Vibrating Sample Magnetometer (VSM).

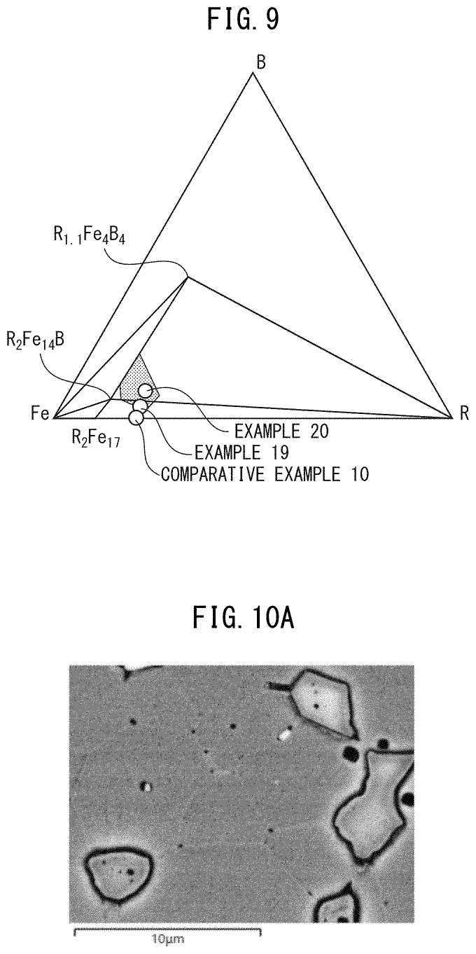

The results are shown in Table 3. In addition, FIG. 9 is a diagram illustrating a composition range of each of the rare earth magnet precursors of Examples 19 and 20 and Comparative Example 10.

TABLE 3

| | Rare Earth Magnet Precursor | | | | | | |
|---|---|---|---|---|---|---|---|
| | | | | Average | | | |
| | | | Volume | Particle | Volume | | |
| | | | Fraction | Diameter | Fraction | Modifier | |
| | | | of Main | of Main | of T2 | | Melting |
| | | | Phase | Phase | Phase | Composition | Point |
| | Composition (at %) | Type | (%) | (μm) | (%) | (molar ratio) | (° C.) |
| Comparative | Nd7.6Ce5.4La1.7FebalB6.4Cu0.1Ga0.3 | sintered magnet | 89.0 | 6.5 | 0 | Nd0.80Fe0.20 | 685 |
| Example 10 | | | | | | | |
| Example 19 | Nd7.5Ce5.7La1.8FebalB5.5Cu0.1Ga0.3 | sintered magnet | 90.0 | 6.7 | 0 | Nd0.80Fe0.20 | 685 |
| Example 20 | Nd7.6Ce5.4La1.7FebalB6.4Cu0.1Ga0.3 | sintered magnet | 90.5 | 6.5 | 1.4 | Nd0.80Fe0.20 | 685 |

| | | | | | | Heat | | |
|---|---|---|---|---|---|---|---|---|
| | Diffusion and Infiltration | | | | | Treatment | | |
| | Diffusion | Diffusion | R3 Diffusion | Diffusion | | Tempera- | | Residual |
| | Infiltration | Infiltration | Infiltration | Infiltration | | ture for | Coercive | Magnet- |
| | Ratio | Ratio | Ratio | Temperature | Cooling Rate | Optimization | Force | ization |
| | (mass ratio) | (molar ratio) | (molar ratio) | (° C.) | (° C./min) | (° C.) | (kA/m) | (T) |
| Comparative | 10 | 5.1 | 3.9 | 950 | 1 | — | 183.0 | 1.03 |
| Example 10 | | | | | | | | |
| Example 19 | 10 | 5.1 | 3.9 | 950 | 1 | — | 423.4 | 1.10 |
| Example 20 | 10 | 5.1 | 3.9 | 950 | 1 | — | 399.4 | 1.15 |

Note 1)
T2 Phase means R1.1Fe4B4 phase.
Note 2)
“Diffusion Infiltration Ratio (mass ratio)” means parts by mass (mass ratio) of modifier relative to 100 parts by mass of rare earth magnet precursor.
Note 3)
“Diffusion Infiltration Ratio (molar ratio)” means parts by mol (molar ratio) of modifier relative to 100 parts by mol of rare earth magnet precursor.
Note 4)
“R3 Diffusion Infiltration Ratio” means parts by mol (molar ratio) of R3 diffused and infiltrated relative to the total (100 parts by mol + q parts by mol) of rare earth magnet precursor and modifier when q parts by mol of modifier is diffused and infiltrated into 100 parts by mol of rare earth magnet precursor.
Note 5)
“Cooling Rate” means a cooling rate up to 500° C.
Note 6)
“—” in the column of “Heat Treatment Temperature for Optimization” means that heat treatment for optimization is not performed.

It could be confirmed that all of the samples of Examples 19 to 20 are excellent in both the coercive force and the residual magnetization. Furthermore, the residual magnetization of the sample of Example 20 is higher than the residual magnetization of the sample of Example 19. This is considered to occur because, as understood from FIG. 9, the content ratio of B is higher in the rare earth magnet precursor of Example 20 than in the rare earth magnet precursor of Example 19 and in turn, a larger amount of R_{1.1}Fe₄B₄ phase is present in the rare earth magnet precursor of Example 20 than in the rare earth magnet precursor of Example 19, as a result, a larger amount of R₂Fe₁₄B phase is formed from a larger amount of R_{1.1}Fe₄B₄ phase in Example 20 than in Example 19 due to Fe of the modifier.

On the other hand, in the sample of Comparative Example 10 where the content ratio of B in the rare earth magnet precursor is very low, it is considered that a large amount of R₂Fe₁₇ phase (a phase having a Th₂Zn₁₇-type and/or Th₂Ni₁₇-type crystal structure) is generated to inhibit the generation of the R₂Fe₁₄B phase (main phase), as a result, the coercive force and the residual magnetization are significantly reduced.

### <Preparation of Samples of Examples 21 and 22 and Comparative Example 11>

The following samples were prepared mainly for verifying the effect of the volume fraction of the main phase of the rare earth magnet precursor.

A strip cast material having the overall composition shown, in terms of molar ratio, in Table 4 was pulverized by hydrogenation and then further pulverized using a jet mill to obtain a magnetic powder. The magnetic powder was molded in a magnetic field of 2 T to obtain a green compact. At this time, the molding pressure was 400 MPa. This green compact was subjected to pressureless sintering at 1,040° C. over 4 hours to obtain a sintered magnet.

The resulting sintered magnet was cutout to 4 mm×4 mm×2 mm (t) and used as a rare earth magnet precursor, and a modifier having the composition shown in Table 4 was diffused and infiltrated into the rare earth magnet precursor. The diffusion and infiltration time was 165 minutes. The rare earth magnet precursor after the diffusion and infiltration of the modifier was then cooled to 500° C. at a rate of 1° C./min and further furnace-cooled.

### <Evaluation of Samples of Examples 21 and 22 and Comparative Example 11>

The magnetic properties of each of the obtained samples were measured at room temperature by using Vibrating Sample Magnetometer (VSM).

The results are shown in Table 4.

TABLE 4

| | Rare Earth Magnet Precursor | | | | | | |
|---|---|---|---|---|---|---|---|
| | | | | Average | | | |
| | | | Volume | Particle | Volume | | |
| | | | Fraction | Diameter | Fraction | Modifier | |
| | | | of Main | of Main | of T2 | | Melting |
| | | | Phase | Phase | Phase | Composition | Point |
| | Composition (at %) | Type | (%) | (μm) | (%) | (molar ratio) | (° C.) |
| Example 21 | Nd7.6Ce5.4La1.7FebalB6.4Cu0.1Ga0.3 | sintered magnet | 90.5 | 6.5 | 1.4 | Nd0.80Fe0.20 | 685 |
| Example 22 | Nd7.6Ce5.4La1.7FebalB6.4Cu0.1Ga0.3 | sintered magnet | 95.9 | 6.1 | 0.4 | Nd0.80Fe0.20 | 685 |
| Comparative | Nd7.6Ce5.4La1.7FebalB6.4Cu0.1Ga0.3 | sintered magnet | 98.0 | 7.5 | 0.2 | Nd0.80Fe0.20 | 685 |
| Example 11 | | | | | | | |

| | | | | | | Heat | | |
|---|---|---|---|---|---|---|---|---|
| | Diffusion and Infiltration | | | | | Treatment | | |
| | Diffusion | Diffusion | R3 Diffusion | Diffusion | | Tempera- | | Residual |
| | Infiltration | Infiltration | Infiltration | Infiltration | | ture for | Coercive | Magnet- |
| | Ratio | Ratio | Ratio | Temperature | Cooling Rate | Optimization | Force | ization |
| | (mass ratio) | (molar ratio) | (molar ratio) | (° C.) | (° C./min) | (° C.) | (kA/m) | (T) |
| Example 21 | 10 | 5.1 | 3.9 | 950 | 1 | — | 399.4 | 1.15 |
| Example 22 | 10 | 5.1 | 3.9 | 950 | 1 | — | 580.9 | 1.30 |
| Comparative | 10 | 5.1 | 3.8 | 950 | 1 | — | 39.8 | 0.93 |
| Example 11 | | | | | | | | |

Note 1)
T2 Phase means R1.1Fe4B4 phase.
Note 2)
“Diffusion Infiltration Ratio (mass ratio)” means parts by mass (mass ratio) of modifier relative to 100 parts by mass of rare earth magnet precursor.
Note 3)
“Diffusion Infiltration Ratio (molar ratio)” means parts by mol (molar ratio) of modifier relative to 100 parts by mol of rare earth magnet precursor.
Note 4)
“R3 Diffusion Infiltration Ratio” means parts by mol (molar ratio) of R3 diffused and infiltrated relative to the total (100 parts by mol + q parts by mol) of rare earth magnet precursor and modifier when q parts by mol of modifier is diffused and infiltrated into 100 parts by mol of rare earth magnet precursor.
Note 5)
“Cooling Rate” means a cooling rate up to 500° C.
Note 6)
“—” in the column of “Heat Treatment Temperature for Optimization” means that heat treatment for optimization is not performed.

It could be confirmed that all of the samples of Examples 21 and 22 are excellent in both the coercive force and the residual magnetization. This is considered to occur because in Examples 21 and 22, the volume fraction of the main phase of the rare earth magnet precursor is within the predetermined range. On the other hand, the sample of Comparative Example 11 is significantly low in both the coercive force and the residual magnetization. This is considered to occur because in Comparative Example 11, the volume fraction of the main phase of the rare earth magnet precursor is excessively large.

### <Preparation of Samples of Examples 23 and 24 and Comparative Example 12>

The following samples were prepared mainly for verifying the effect of the content ratio of B of the rare earth magnet precursor in the case of using a Fe-containing modifier.

A strip cast material having the overall composition shown, in terms of molar ratio, in Table 5 was pulverized by hydrogenation and then further pulverized using a jet mill to obtain a magnetic powder. The magnetic powder was molded in a magnetic field of 2 T to obtain a green compact. At this time, the molding pressure was 400 MPa. This green compact was subjected to pressureless sintering at 1,040° C. over 4 hours to obtain a sintered magnet.

The resulting sintered magnet was cutout to 4 mm×4 mm×2 mm (t) and used as a rare earth magnet precursor, and a modifier having the composition shown in Table 5 was diffused and infiltrated into the rare earth magnet precursor. The diffusion and infiltration time was 165 minutes. The rare earth magnet precursor after the diffusion and infiltration of the modifier was then cooled to 500° C. at a rate of 1° C./min and further furnace-cooled.

### <Evaluation of Samples of Examples 23 and 24 and Comparative Example 12>

The magnetic properties of each of the obtained samples were measured at room temperature by using Vibrating Sample Magnetometer (VSM).

The results are shown in Table 5.

TABLE 5

| | Rare Earth Magnet Precursor | | | | | | |
|---|---|---|---|---|---|---|---|
| | | | | Average | | | |
| | | | Volume | Particle | Volume | | |
| | | | Fraction | Diameter | Fraction | Modifier | |
| | | | of Main | of Main | of T2 | | Melting |
| | | | Phase | Phase | Phase | Composition | Point |
| | Composition (at %) | Type | (%) | (μm) | (%) | (molar ratio) | (° C.) |
| Example 23 | Nd6.6Ce4.9La1.6FebalB6Cu0.1Ga0.3 | sintered magnet | 95.9 | 6.1 | 0.4 | Nd0.80Fe0.20 | 685 |
| Example 24 | Nd6.7Ce5.0La1.6FebalB6.61Cu0.1Ga0.3 | sintered magnet | 94.0 | 5.8 | 1.8 | Nd0.80Fe0.20 | 685 |
| Comparative | Nd6.2Ce4La1.6FebalB21Cu0.1Ga0.3 | sintered magnet | 64.3 | 5.0 | 35.4 | Nd0.80Fe0.20 | 685 |
| Example 12 | | | | | | | |

| | | | | | | Heat | | |
|---|---|---|---|---|---|---|---|---|
| | Diffusion and Infiltration | | | | | Treatment | | |
| | Diffusion | Diffusion | R3 Diffusion | Diffusion | | Tempera- | | Residual |
| | Infiltration | Infiltration | Infiltration | Infiltration | | ture for | Coercive | Magnet- |
| | Ratio | Ratio | Ratio | Temperature | Cooling Rate | Optimization | Force | ization |
| | (mass ratio) | (molar ratio) | (molar ratio) | (° C.) | (° C./min) | (° C.) | (kA/m) | (T) |
| Example 23 | 10 | 5.1 | 3.9 | 950 | 1 | — | 580.9 | 1.30 |
| Example 24 | 10 | 5.1 | 3.9 | 950 | 1 | — | 485.4 | 1.24 |
| Comparative | 10 | 5.1 | 3.9 | 950 | 1 | — | 167.1 | 1.01 |
| Example 12 | | | | | | | | |

Note 1)
T2 Phase means R1.1Fe4B4 phase.
Note 2)
“Diffusion Infiltration Ratio (mass ratio)” means parts by mass (mass ratio) of modifier relative to 100 parts by mass of rare earth magnet precursor.
Note 3)
“Diffusion Infiltration Ratio (molar ratio)” means parts by mol (molar ratio) of modifier relative to 100 parts by mol of rare earth magnet precursor.
Note 4)
“R3 Diffusion Infiltration Ratio” means parts by mol (molar ratio) of R3 diffused and infiltrated relative to the total (100 parts by mol + q parts by mol) of rare earth magnet precursor and modifier when q parts by mol of modifier is diffused and infiltrated into 100 parts by mol of rare earth magnet precursor.
Note 5)
“Cooling Rate” means a cooling rate up to 500° C.
Note 6)
“—” in the column of “Heat Treatment Temperature for Optimization” means that heat treatment for optimization is not performed.

It could be confirmed that all of the samples of Examples 23 and 24 are excellent in both the coercive force and the residual magnetization. This is considered to occur because R₂Fe₁₄B phase is formed from R_{1.1}Fe₄B₄ phase due to Fe of the modifier.

On the other hand, in the sample of Comparative Example 12, the content ratio of B in the rare earth magnet precursor is excessively large and in turn, an excess of R_{1.1}Fe₄B₄ phase is generated. It is considered that in the sample of Comparative Example 12, although the R₂Fe₁₄B phase is formed from part of R_{1.1}Fe₄B₄ phase due to Fe of the modifier, a lot of R_{1.1}Fe₄B₄ phase remains as it is, as a result, the sample of Comparative Example 12 lacks R₂Fe₁₄B phase, leading to reduction of the residual magnetization, and since the rare earth element-rich phase surrounding the main phase is relatively decreased, the coercive force is reduced.

### <Preparation of Samples of Example 25 and Comparative Example 13>

The following samples were prepared mainly for verifying the effect of the average particle diameter of the main phase of the rare earth magnet precursor.

A strip cast material having an overall composition represented, in terms of molar ratio, by Nd_{6.6}Ce_{4.9}La_{1.6}Fe_{bal}B_{6.0}Cu_{0.1}Ga_{0.3} was pulverized by hydrogenation and then further pulverized using a jet mill to obtain a magnetic powder. The magnetic powder was molded in a magnetic field of 2 T to obtain a green compact. At this time, the molding pressure was 200 MPa. This green compact was subjected to pressureless sintering at 1,040° C. over 4 hours to obtain a sintered magnet.

The resulting sintered magnet was cutout to 4 mm×4 mm×2 mm (t) and used as a rare earth magnet precursor, and a modifier having the composition shown in Table 6 was diffused and infiltrated at 950° C. into the rare earth magnet precursor. The diffusion and infiltration time was 165 minutes. The rare earth magnet precursor after the diffusion and infiltration of the modifier was then cooled to 500° C. at a rate of 10° C./min and further furnace-cooled. This is designated as the sample of Example 25.

A magnetic powder having the same composition as the sintered magnet of Example 25 and having a nanocrystallized main phase was subjected to hot pressing (low-temperature pressure sintering) to obtain a sintered body. This sintered body was subjected to hot plastic working to obtain a hot-worked magnet.

The resulting hot-plastic worked magnet was cutout to 4 mm×4 mm×2 mm (t) and used as a rare earth magnet precursor, and a modifier having the composition shown in Table 6 was diffused and infiltrated at 950° C. into the rare earth magnet precursor. The diffusion and infiltration time was 165 minutes. The rare earth magnet precursor after the diffusion and infiltration of the modifier was then cooled to 500° C. at a rate of 10° C./min and further furnace-cooled. This is designated as the sample of Comparative Example 13.

### <Evaluation of Samples of Example 25 and Comparative Example 13>

The magnetic properties of each of the obtained samples were measured at room temperature by using Vibrating Sample Magnetometer (VSM). In addition, area analysis was performed using SEM-EDX on both samples of Example 25 and Comparative Example 13.

The results are shown in Table 6.

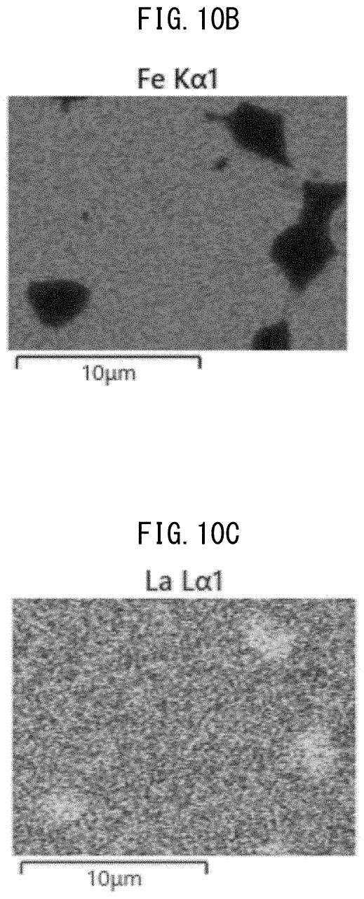

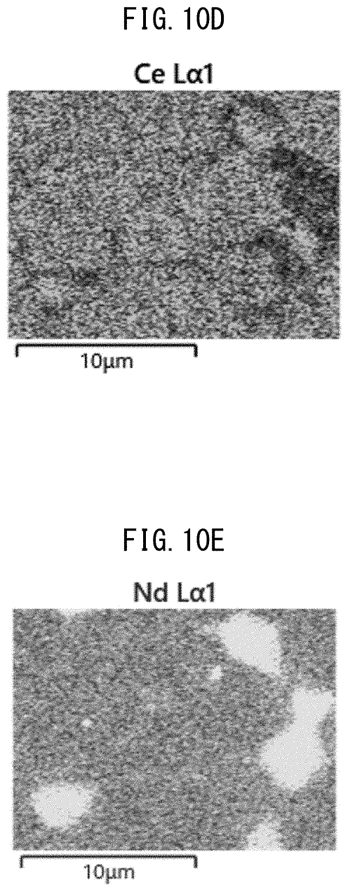

FIG. 10A is a diagram illustrating the results when the sample of Example 25 is observed by SEM. FIG. 10B is a diagram illustrating the results when area analysis of Fe is performed using SEM-EDX with respect to the region shown in FIG. 10A. FIG. 10C is a diagram illustrating the results when area analysis of La is performed using SEM-EDX with respect to the region shown in FIG. 10A. FIG. 10D is a diagram illustrating the results when area analysis of Ce is performed using SEM-EDX with respect to the region shown in FIG. 10A. FIG. 10E is a diagram illustrating the results when area analysis of Nd is performed using SEM-EDX with respect to the region shown in FIG. 10A. In FIGS. 10B to 10E, the bright field indicates that the concentration of the area-analyzed element is high.

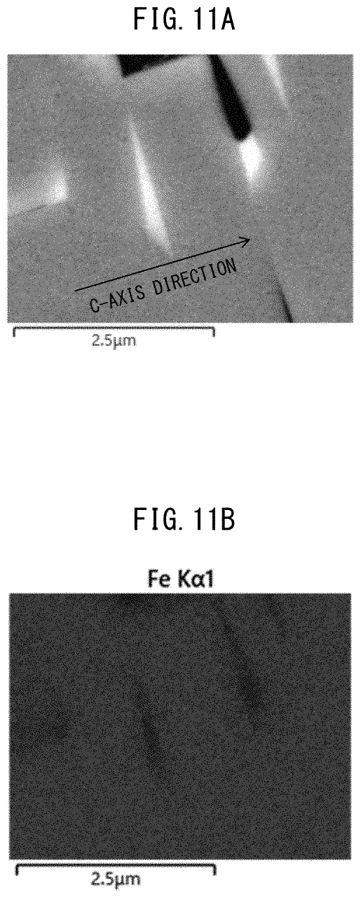

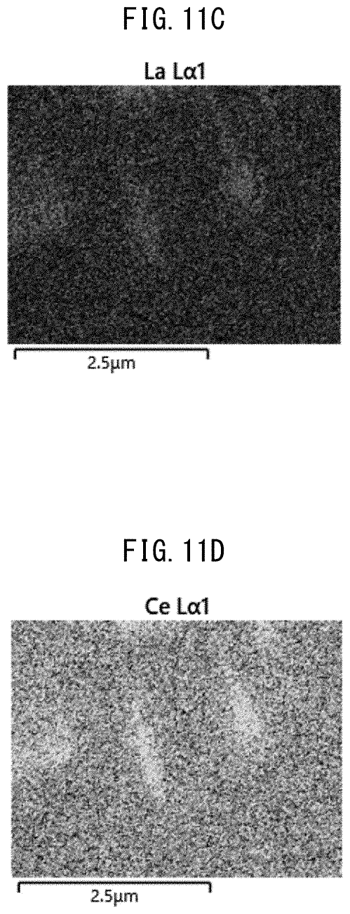

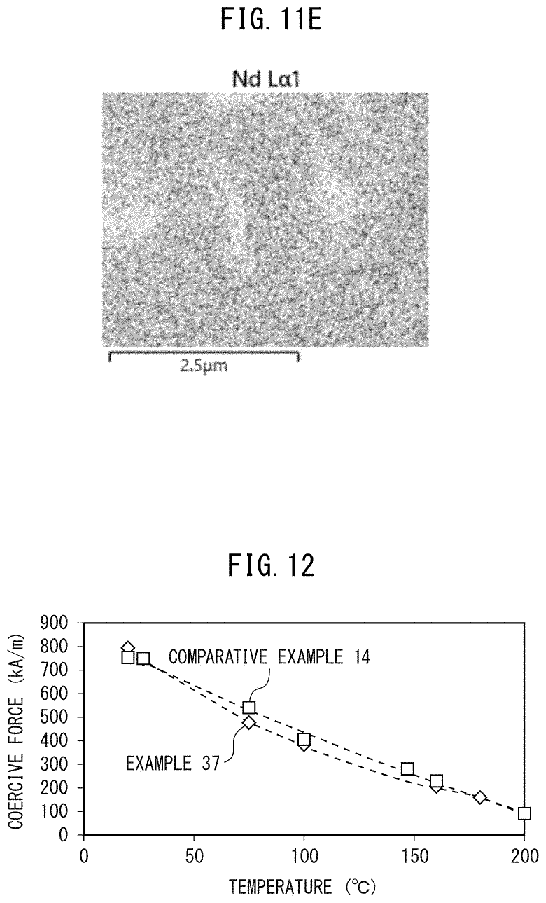

FIG. 11A is a diagram illustrating the results when the sample of Comparative Example 13 is observed by SEM. FIG. 11B is a diagram illustrating the results when area analysis of Fe is performed using SEM-EDX with respect to the region shown in FIG. 11A. FIG. 11C is a diagram illustrating the results when area analysis of La is performed using SEM-EDX with respect to the region shown in FIG. 11A. FIG. 11D is a diagram illustrating the results when area analysis of Ce is performed using SEM-EDX with respect to the region shown in FIG. 11A. FIG. 11E is a diagram illustrating the results when area analysis of Nd is performed using SEM-EDX with respect to the region shown in FIG. 11A. In FIGS. 11B to 11E, the bright field indicates that the concentration of the area-analyzed element is high.

TABLE 6

| | Rare Earth Magnet Precursor | | | | | | |
|---|---|---|---|---|---|---|---|
| | | | | Average | | | |
| | | | Volume | Particle | Volume | | |
| | | | Fraction | Diameter | Fraction | Modifier | |
| | | | of Main | of Main | of T2 | | Melting |
| | | | Phase | Phase | Phase | Composition | Point |
| | Composition (at %) | Type | (%) | (μm) | (%) | (molar ratio) | (° C.) |
| Comparative | Nd6.6Ce4.9La1.6FebalB6Cu0.1Ga0.3 | hot-plastic | 95.9 | 0.35 | 0.4 | Nd0.90Cu0.10 | 848 |
| Example 13 | | worked magnet | | | | | |
| Example 25 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |

| | | | | | | Heat | | |
|---|---|---|---|---|---|---|---|---|
| | Diffusion and Infiltration | | | | | Treatment | | |
| | Diffusion | Diffusion | R3 Diffusion | Diffusion | | Tempera- | | Residual |
| | Infiltration | Infiltration | Infiltration | Infiltration | | ture for | Coercive | Magnet- |
| | Ratio | Ratio | Ratio | Temperature | Cooling Rate | Optimization | Force | ization |
| | (mass ratio) | (molar ratio) | (molar ratio) | (° C.) | (° C./min) | (° C.) | (kA/m) | (T) |
| Comparative | 10 | 4.8 | 4.1 | 950 | 1 | — | 334.2 | 1.10 |
| Example 13 | | | | | | | | |
| Example 25 | 10 | 4.8 | 4.1 | 950 | 1 | — | 628.7 | 1.28 |

Note 1)
T2 Phase means R1.1Fe4B4 phase.
Note 2)
“Diffusion Infiltration Ratio (mass ratio)” means parts by mass (mass ratio) of modifier relative to 100 parts by mass of rare earth magnet precursor.
Note 3)
“Diffusion Infiltration Ratio (molar ratio)” means parts by mol (molar ratio) of modifier relative to 100 parts by mol of rare earth magnet precursor.
Note 4)
“R3 Diffusion Infiltration Ratio” means parts by mol (molar ratio) of R3 diffused and infiltrated relative to the total (100 parts by mol + q parts by mol) of rare earth magnet precursor and modifier when q parts by mol of modifier is diffused and infiltrated into 100 parts by mol of rare earth magnet precursor.
Note 5)
“Cooling Rate” means a cooling rate up to 500° C.
Note 6)
“—” in the column of “Heat Treatment Temperature for Optimization” means that heat treatment for optimization is not performed.

It could be confirmed from Table 6 that the sample of Example 25 is excellent in both the coercive force and the residual magnetization. In addition, it could be confirmed from FIG. 10A that even when the modifier is diffused and infiltrated at 950° C., the main phase is substantially not coarsened. It is considered from these results that a predetermined shell portion is formed by the diffusion and infiltration at a high temperature (950° C.) and both the coercive force and the residual magnetization can be enhanced.

On the other hand, it could be confirmed from Table 6 that in the sample of Comparative Example 13, both the coercive force and the residual magnetization are low. In addition, it could be confirmed from FIG. 11A that the main phase is significantly coarsened and at the same time, main phases are fused to each other, making it unlikely for a core portion and a shell portion to be formed in the inside of the main phase. It is considered from these results that when a modifier is diffused and infiltrated at a high temperature (950° C.) into a rare earth magnet precursor having a nanocrystallized main phase, not only the main phase is coarsened but also the structure of the main phase consisting of a core portion and a shell portion is damaged.

Incidentally, with respect to the sample of Example 25, FIG. 10C (results of area analysis of Ce) and FIG. 10D (results of area analysis of Nd) show a tendency that part of Ce is replaced by Nd in the shell portion and the Nd concentration is slightly higher in the shell portion than in the core portion. However, the results of area analysis using SEM-EDX do not clearly reveal that the concentration of the rare earth element (Nd) other than the light rare earth (Ce) is significantly higher in the shell portion than in the core portion. Then, as described later, this was verified by performing area analysis by means of Cs-STEM-EDX on the samples of Examples 22, 37, 44, 54 and 55 and Comparative Example 14.

### <Preparation of Samples of Examples 26 to 29>

The following samples were prepared mainly for verifying the effect of the cooling rate after the diffusion and infiltration of the modifier.

A strip cast material having an overall composition represented, in terms of molar ratio, by Nd_{7.6}Ce_{5.4}La_{1.7}Fe_{bal}B_{6.4}Cu_{0.1}Ga_{0.3} was pulverized by hydrogenation and then further pulverized using a jet mill to obtain a magnetic powder. The magnetic powder was molded in a magnetic field of 2 T to obtain a green compact. At this time, the molding pressure was 200 MPa. This green compact was subjected to pressureless sintering at 1,040° C. over 4 hours to obtain a sintered magnet.

The resulting sintered magnet was cutout to 4 mm×4 mm×2 mm (t) and used as a rare earth magnet precursor, and a modifier having the composition shown in Table 7 was diffused and infiltrated at 950° C. into the rare earth magnet precursor. The diffusion and infiltration time was 165 minutes. The rare earth magnet precursor after the diffusion and infiltration of the modifier was then cooled to 500° C. at a rate of 10° C./min or 1° C./min and further furnace-cooled.

### <Evaluation of Samples of Examples 26 to 29>

The magnetic properties of each of the obtained samples were measured at room temperature by using Vibrating Sample Magnetometer (VSM).

The results are shown in Table 7.

TABLE 7

| | Rare Earth Magnet Precursor | | | | | | |
|---|---|---|---|---|---|---|---|
| | | | | Average | | | |
| | | | Volume | Particle | Volume | | |
| | | | Fraction | Diameter | Fraction | Modifier | |
| | | | of Main | of Main | of T2 | | Melting |
| | | | Phase | Phase | Phase | Composition | Point |
| | Composition (at %) | Type | (%) | (μm) | (%) | (molar ratio) | (° C.) |
| Example 26 | Nd7.6Ce5.4La1.7FebalB6.4Cu0.1Ga0.3 | sintered | 90.5 | 6.5 | 1.4 | Nd0.80Fe0.10Al0.10 | 718 |
| | | magnet | | | | | |
| Example 27 | Nd7.6Ce5.4La1.7FebalB6.4Cu0.1Ga0.3 | sintered | 90.5 | 6.5 | 1.4 | Nd0.80Fe0.10Al0.10 | 718 |
| | | magnet | | | | | |
| Example 28 | Nd7.6Ce5.4La1.7FebalB6.4Cu0.1Ga0.3 | sintered | 90.5 | 6.5 | 1.4 | Nd0.85Al0.15 | 635 |
| | | magnet | | | | | |
| Example 29 | Nd7.6Ce5.4La1.7FebalB6.4Cu0.lGa0.3 | sintered | 90.5 | 6.5 | 1.4 | Nd0.85Al0.15 | 635 |
| | | magnet | | | | | |

| | | | | | | Heat | | |
|---|---|---|---|---|---|---|---|---|
| | Diffusion and Infiltration | | | | | Treatment | | |
| | Diffusion | Diffusion | R3 Diffusion | Diffusion | | Tempera- | | Residual |
| | Infiltration | Infiltration | Infiltration | Infiltration | | ture for | Coercive | Magnet- |
| | Ratio | Ratio | Ratio | Temperature | Cooling Rate | Optimization | Force | ization |
| | (mass ratio) | (molar ratio) | (molar ratio) | (° C.) | (° C./min) | (° C.) | (kA/m) | (T) |
| Example 26 | 10 | 5.3 | 4.0 | 950 | 10 | — | 449.5 | 1.16 |
| Example 27 | 10 | 5.3 | 4.0 | 950 | 1 | — | 554.2 | 1.16 |
| Example 28 | 10 | 5.2 | 4.2 | 950 | 10 | — | 397.3 | 1.14 |
| Example 29 | 10 | 5.2 | 4.2 | 950 | 1 | — | 551.1 | 1.13 |

Note 1)
T2 Phase means R1.1Fe4B4 phase.
Note 2)
“Diffusion Infiltration Ratio (mass ratio)” means parts by mass (mass ratio) of modifier relative to 100 parts by mass of rare earth magnet precursor.
Note 3)
“Diffusion Infiltration Ratio (molar ratio)” means parts by mol (molar ratio) of modifier relative to 100 parts by mol of rare earth magnet precursor.
Note 4)
“R3 Diffusion Infiltration Ratio” means parts by mol (molar ratio) of R3 diffused and infiltrated relative to the total (100 parts by mol + q parts by mol) of rare earth magnet precursor and modifier when q parts by mol of modifier is diffused and infiltrated into 100 parts by mol of rare earth magnet precursor.
Note 5)
“Cooling Rate” means a cooling rate up to 500° C.
Note 6)
“—” in the column of “Heat Treatment Temperature for Optimization” means that heat treatment for optimization is not performed.

It could be confirmed from Table 7 that the samples of Examples 26 to 29 are excellent in both the coercive force and the residual magnetization. In addition, it could be confirmed that the samples of Examples 27 and 29 are further excellent in the coercive force, compared with those of Examples 26 and 28. This is considered to be attributable to the face that, as described above, the interface between the shell portion and the grain boundary phase is a facet surface.

### <Preparation of Samples of Examples 30 to 53>

The following samples were prepared mainly for verifying the effect of the contact amount of the modifier and the heat treatment for optimization.

A strip cast material having an overall composition represented, in terms of molar ratio, by Nd_{6.6}Ce_{4.9}La_{1.6}Fe_{bal}B_{6.0}Cu_{0.1}Ga_{0.3} was pulverized by hydrogenation and then further pulverized using a jet mill to obtain a magnetic powder. The magnetic powder was molded in a magnetic field of 2 T to obtain a green compact. At this time, the molding pressure was 200 MPa. This green compact was subjected to pressureless sintering at 1,040° C. over 4 hours to obtain a sintered magnet.

The resulting sintered magnet was cutout to 4 mm×4 mm×2 mm (t) and used as a rare earth magnet precursor, and a modifier having the composition shown in Table 8 was diffused and infiltrated into the rare earth magnet precursor. The diffusion and infiltration time was 165 minutes. The rare earth magnet precursor after the diffusion and infiltration of the modifier was then cooled to 500° C. at a rate of 1° C./min and further furnace-cooled.

After the furnace cooling, the samples of Examples 33 to 41 and Examples 45 to 53 were further heat-treated at the temperature shown in Table 8 (heat treatment for optimization). The heat treatment was performed in an argon gas atmosphere.

### <Evaluation of Samples of Examples 30 to 53>

The magnetic properties of each of the obtained samples were measured at room temperature by using Vibrating Sample Magnetometer (VSM).

The results are shown in Table 8.

TABLE 8

| | Rare Earth Magnet Precursor | | | | | | |
|---|---|---|---|---|---|---|---|
| | | | | Average | | | |
| | | | Volume | Particle | Volume | | |
| | | | Fraction | Diameter | Fraction | Modifier | |
| | | | of Main | of Main | of T2 | | Melting |
| | | | Phase | Phase | Phase | Composition | Point |
| | Composition (at %) | Type | (%) | (μm) | (%) | (molar ratio) | (° C.) |
| Example 30 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |
| Example 31 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |
| Example 32 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |
| Example 33 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |
| Example 34 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |
| Example 35 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |
| Example 36 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |
| Example 37 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |
| Example 38 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |
| Example 39 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |
| Example 40 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |

| | | | | | | Heat | | |
|---|---|---|---|---|---|---|---|---|
| | Diffusion and Infiltration | | | | | Treatment | | |
| | Diffusion | Diffusion | R3 Diffusion | Diffusion | | Tempera- | | Residual |
| | Infiltration | Infiltration | Infiltration | Infiltration | | ture for | Coercive | Magnet- |
| | Ratio | Ratio | Ratio | Temperature | Cooling Rate | Optimization | Force | ization |
| | (mass ratio) | (molar ratio) | (molar ratio) | (° C.) | (° C./min) | (° C.) | (kA/m) | (T) |
| Example 30 | 10 | 4.7 | 4.1 | 950 | 1 | — | 628.7 | 1.28 |
| Example 31 | 15 | 7.1 | 6.0 | 950 | 1 | — | 676.4 | 1.28 |
| Example 32 | 20 | 9.5 | 7.8 | 950 | 1 | — | 668.5 | 1.27 |
| Example 33 | 10 | 4.7 | 4.1 | 950 | 1 | 450 | 660.5 | 1.28 |
| Example 34 | 15 | 7.1 | 6.0 | 950 | 1 | 450 | 700.3 | 1.28 |
| Example 35 | 20 | 9.5 | 7.8 | 950 | 1 | 450 | 652.5 | 1.27 |
| Example 36 | 10 | 4.7 | 4.1 | 950 | 1 | 500 | 716.2 | 1.29 |
| Example 37 | 15 | 7.1 | 6.0 | 950 | 1 | 500 | 795.8 | 1.29 |
| Example 38 | 20 | 9.5 | 7.8 | 950 | 1 | 500 | 763.9 | 1.26 |
| Example 39 | 10 | 4.7 | 4.1 | 950 | 1 | 550 | 612.7 | 1.28 |
| Example 40 | 15 | 7.1 | 6.0 | 950 | 1 | 550 | 724.2 | 1.30 |

| | Rare Earth Magnet Precursor | | | | | | |
|---|---|---|---|---|---|---|---|
| | | | | Average | | | |
| | | | Volume | Particle | Volume | | |
| | | | Fraction | Diameter | Fraction | Modifier | |
| | | | of Main | of Main | of T2 | | Melting |
| | | | Phase | Phase | Phase | Composition | Point |
| | Composition (at %) | Type | (%) | (μm) | (%) | (molar ratio) | (° C.) |
| Example 41 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |
| Example 42 | Nd6.6Ce4.9La1.6FebalB6Cu0.1Ga0.3 | sintered | 95.9 | 6.1 | 0.4 | Nd0.80Fe0.10Al0.10 | 718 |
| | | magnet | | | | | |
| Example 43 | Nd6.6Ce4.9La1.6FebalB6Cu0.1Ga0.3 | sintered | 95.9 | 6.1 | 0.4 | Nd0.80Fe0.10Al0.10 | 718 |
| | | magnet | | | | | |
| Example 44 | Nd6.6Ce4.9La1.6FebalB6Cu0.1Ga0.3 | sintered | 95.9 | 6.1 | 0.4 | Nd0.80Fe0.10Al0.10 | 718 |
| | | magnet | | | | | |
| Example 45 | Nd6.6Ce4.9La1.6FebalB6Cu0.1Ga0.3 | sintered | 95.9 | 6.1 | 0.4 | Nd0.80Fe0.10Al0.10 | 718 |
| | | magnet | | | | | |
| Example 46 | Nd6.6Ce4.9La1.6FebalB6Cu0.1Ga0.3 | sintered | 95.9 | 6.1 | 0.4 | Nd0.80Fe0.10Al0.10 | 718 |
| | | magnet | | | | | |
| Example 47 | Nd6.6Ce4.9La1.6FebalB6Cu0.1Ga0.3 | sintered | 95.9 | 6.1 | 0.4 | Nd0.80Fe0.10Al0.10 | 718 |
| | | magnet | | | | | |
| Example 48 | Nd6.6Ce4.9La1.6FebalB6Cu0.1Ga0.3 | sintered | 95.9 | 6.1 | 0.4 | Nd0.80Fe0.10Al0.10 | 718 |
| | | magnet | | | | | |
| Example 49 | Nd6.6Ce4.9La1.6FebalB6Cu0.1Ga0.3 | sintered | 95.9 | 6.1 | 0.4 | N0.d80Fe0.10Al0.10 | 718 |
| | | magnet | | | | | |
| Example 50 | Nd6.6Ce4.9La1.6FebalB6Cu0.1Ga0.3 | sintered | 95.9 | 6.1 | 0.4 | Nd0.80Fe0.10Al0.10 | 718 |
| | | magnet | | | | | |
| Example 51 | Nd6.6Ce4.9La1.6FebalB6Cu0.1Ga0.3 | sintered | 95.9 | 6.1 | 0.4 | Nd0.80Fe0.10Al0.10 | 718 |
| | | magnet | | | | | |
| Example 52 | Nd6.6Ce4.9La1.6FebalB6Cu0.1Ga0.3 | sintered | 95.9 | 6.1 | 0.4 | Nd0.80Fe0.10Al0.10 | 718 |
| | | magnet | | | | | |
| Example 53 | Nd6.6Ce4.9La1.6FebalB6Cu0.1Ga0.3 | sintered | 95.9 | 6.1 | 0.4 | Nd0.80Fe0.10Al0.10 | 718 |
| | | magnet | | | | | |

| | | | | | | Heat | | |
|---|---|---|---|---|---|---|---|---|
| | Diffusion and Infiltration | | | | | Treatment | | |
| | Diffusion | Diffusion | R3 Diffusion | Diffusion | | Tempera- | | Residual |
| | Infiltration | Infiltration | Infiltration | Infiltration | | ture for | Coercive | Magnet- |
| | Ratio | Ratio | Ratio | Temperature | Cooling Rate | Optimization | Force | ization |
| | (mass ratio) | (molar ratio) | (molar ratio) | (° C.) | (° C./min) | (° C.) | (kA/m) | (T) |
| Example 41 | 20 | 9.5 | 7.8 | 950 | 1 | 550 | 668.5 | 1.26 |
| Example 42 | 10 | 5.2 | 4.0 | 950 | 1 | — | 636.6 | 1.30 |
| Example 43 | 15 | 7.8 | 5.8 | 950 | 1 | — | 668.5 | 1.34 |
| Example 44 | 20 | 10.4 | 7.6 | 950 | 1 | — | 684.4 | 1.25 |
| Example 45 | 10 | 5.2 | 4.0 | 950 | 1 | 450 | 763.9 | 1.28 |
| Example 46 | 15 | 7.8 | 5.8 | 950 | 1 | 450 | 604.8 | 1.30 |
| Example 47 | 20 | 10.4 | 7.6 | 950 | 1 | 450 | 708.2 | 1.26 |
| Example 48 | 10 | 5.2 | 4.0 | 950 | 1 | 500 | 740.1 | 1.30 |
| Example 49 | 15 | 7.8 | 5.8 | 950 | 1 | 500 | 819.6 | 1.29 |
| Example 50 | 20 | 10.4 | 7.6 | 950 | 1 | 500 | 763.9 | 1.24 |
| Example 51 | 10 | 5.2 | 4.0 | 950 | 1 | 550 | 756.0 | 1.30 |
| Example 52 | 15 | 7.8 | 5.8 | 950 | 1 | 550 | 763.9 | 1.26 |
| Example 53 | 20 | 10.4 | 7.6 | 950 | 1 | 550 | 819.6 | 1.28 |

Note 1)
T2 Phase means R1.1Fe4B4 phase.
Note 2)
“Diffusion Infiltration Ratio (mass ratio)” means parts by mass (mass ratio) of modifier relative to 100 parts by mass of rare earth magnet precursor.
Note 3)
“Diffusion Infiltration Ratio (molar ratio)” means parts by mol (molar ratio) of modifier relative to 100 parts by mol of rare earth magnet precursor.
Note 4)
“R3 Diffusion Infiltration Ratio” means parts by mol (molar ratio) of R3 diffused and infiltrated relative to the total (100 parts by mol + q parts by mol) of rare earth magnet precursor and modifier when q parts by mol of modifier is diffused and infiltrated into 100 parts by mol of rare earth magnet precursor.
Note 5)
“Cooling Rate” means a cooling rate up to 500° C.
Note 6)
“—” in the column of “Heat Treatment Temperature for Optimization” means that heat treatment for optimization is not performed.

It could be confirmed from Table 8 that the samples of Examples 30 to 53 are excellent in both the coercive force and the residual magnetization. Then, it could be confirmed that both the coercive force and the residual magnetization are higher in the sample where from 7.1 to 7.8 parts by mol of the modifier is diffused and infiltrated relative to 100 parts by mol of the rare earth magnet precursor, than in the sample where from 4.7 to 5.2 parts by mol of the modifier is diffused an infiltrated. In addition, it could be confirmed that compared with the sample where from 7.1 to 7.8 parts by mol of the modifier is diffused and infiltrated relative to 100 parts by mol of the rare earth magnet precursor, in the sample where from 9.5 to 10.4 parts by mol of the modifier is diffused and infiltrated, the coercive force tends to be further enhanced, but the enhancement of the residual magnetization is being saturated.

Furthermore, it could be confirmed from Table 8 that compared with the sample to which heat treatment for optimization is not applied, in the sample subjected to heat treatment for optimization, the coercive force is enhanced. It could also be confirmed that the coercive force-enhancing effect is particularly high at 500 to 550° C.

### <Preparation of Samples of Example 37 and Comparative Example 14>

The following samples were prepared mainly for verifying the magnetic properties at a high temperature (75 to 200° C.).

The method for preparing the rare earth magnet precursor of Example 37 is as described above (see, Table 8, etc.). Then, the rare earth magnet precursor of Comparative Example 14 was prepared by the same method as the rare earth magnet precursor of Example 37 except that the rare earth magnet precursor is a hot-plastic worked magnet. More specifically, in the rare earth magnet precursor of Example 37, the main phase is a microcrystal and the anisotropy is imparted by the molding in a magnetic field, whereas in the rare earth magnet precursor of Comparative Example 14, the main phase is a nanocrystal and the anisotropy is imparted by hot-plastic working.

The outline of the method for preparing the rare earth magnet precursor of Comparative Example 14 is as follows. A molten metal having the same composition as the rare earth magnet precursor of Example 37 was liquid-quenched to obtain a rapid-quenched ribbon. This rapid-quenched ribbon was subjected to hot pressing (temperature: 650° C., pressure: 400 MPa) to obtain a molded body. This molded body was subjected to hot-plastic working (temperature: 780° C., strain rate: 0.1 s⁻¹, working rate: 70%) to obtain a rare earth magnet precursor.

A modifier having the composition shown in Table 9 was diffused and infiltrated into the obtained rare earth magnet precursor (size: 4 mm×4 mm×2 mm (t)). In the rare earth magnet precursor of Example 37, the modifier was diffused and infiltrated at a high temperature (950° C.), and in the sample of Comparative Example 14, the modifier was diffused and infiltrated at a low temperature (650° C.). The diffusion and infiltration time was 165 minutes. Other conditions are as shown in Table 9.

### <Evaluation of Samples of Example 37 and Comparative Example 14>

The magnetic properties of each of the obtained samples were measured in the range of room temperature to 200° C. by using Vibrating Sample Magnetometer (VSM).

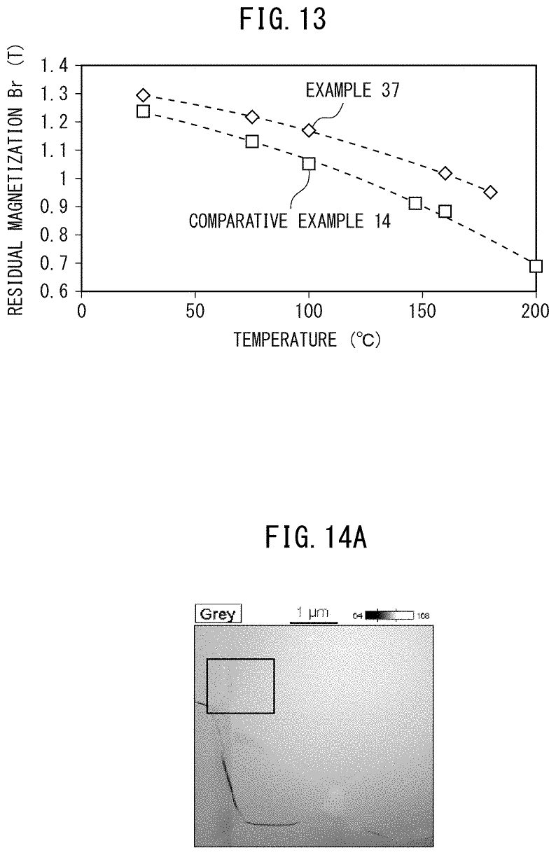

The results are shown in Table 9. The coercive force and residual magnetization shown in Table 9 were measured at room temperature. In addition, FIG. 12 is a graph illustrating the relationship between the temperature and the coercive force with respect to the samples of Example 37 and Comparative Example 14. FIG. 13 is a graph illustrating the relationship between the temperature and the residual magnetization with respect to the samples of Example 37 and Comparative Example 14.

TABLE 9

| | Rare Earth Magnet Precursor | | | | | | |
|---|---|---|---|---|---|---|---|
| | | | | Average | | | |
| | | | Volume | Particle | Volume | | |
| | | | Fraction | Diameter | Fraction | Modifier | |
| | | | of Main | of Main | of T2 | | Melting |
| | | | Phase | Phase | Phase | Composition | Point |
| | Composition (at %) | Type | (%) | (μm) | (%) | (molar ratio) | (° C.) |
| Comparative | Nd6.6Ce4.9La1.6FebalB6Cu0.1Ga0.3 | hot-plastic | 95.9 | 0.35 | 0.4 | Nd0.70Cu0.30 | 520 |
| Example 14 | | worked magnet | | | | | |
| Example 37 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |

| | | | | | | Heat | | |
|---|---|---|---|---|---|---|---|---|
| | Diffusion and Infiltration | | | | | Treatment | | |
| | Diffusion | Diffusion | R3 Diffusion | Diffusion | | Tempera- | | Residual |
| | Infiltration | Infiltration | Infiltration | Infiltration | | ture for | Coercive | Magnet- |
| | Ratio | Ratio | Ratio | Temperature | Cooling Rate | Optimization | Force | ization |
| | (mass ratio) | (molar ratio) | (molar ratio) | (° C.) | (° C./min) | (° C.) | (kA/m) | (T) |
| Comparative | 10 | 5.5 | 3.6 | 650 | 10 | — | 756 | 1.24 |
| Example 14 | | | | | | | | |
| Example 37 | 15 | 7.1 | 6.0 | 950 | 1 | 500 | 795.8 | 1.29 |

Note 1)
T2 Phase means R1.1Fe4B4 phase.
Note 2)
“Diffusion Infiltration Ratio (mass ratio)” means parts by mass (mass ratio) of modifier relative to 100 parts by mass of rare earth magnet precursor.
Note 3)
“Diffusion Infiltration Ratio (molar ratio)” means parts by mol (molar ratio) of modifier relative to 100 parts by mol of rare earth magnet precursor.
Note 4)
“R3 Diffusion Infiltration Ratio” means parts by mol (molar ratio) of R3 diffused and infiltrated relative to the total (100 parts by mol + q parts by mol) of rare earth magnet precursor and modifier when q parts by mol of modifier is diffused and infiltrated into 100 parts by mol of rare earth magnet precursor.
Note 5)
“Cooling Rate” means a cooling rate up to 500° C.
Note 6)
“—” in the column of “Heat Treatment Temperature for Optimization” means that heat treatment for optimization is not performed.

It could be confirmed from Table 9 that the sample of Example 37 is excellent in both the coercive force and the residual magnetization. In addition, it could be confirmed from FIG. 12 that the coercive force of the sample of Example 37 is substantially equal to that of the sample of Comparative Example 13 at respective temperatures. Furthermore, it could be confirmed from FIG. 13, the residual magnetization of the sample of Example 37 is more excellent than the residual magnetization of the sample of Comparative Example 13 at respective temperatures. Then, it could be confirmed that the reduction in the residual magnetization due to the temperature rise is small in the sample of Example 37, compared with the sample of Comparative Example 13.

From these results, it could be ascertained that both of the coercive force and the residual magnetization are more excellent in the case of diffusing the modifier at a high temperature into a rare earth magnet precursor having a microcrystal main phase than in the case of diffusing and infiltrating the modifier at a low temperature into a rare earth magnet precursor having a nanocrystallized main phase.

### <Preparation of Samples of Examples 22, 37, 44, 54 and 55 and Comparative Example 14>

The following samples were prepared mainly for verifying the structures of the core portion and the shell portion.

The preparation method for the samples of Examples 22, 37 and 44 and Comparative Example 14 are as described above (see, Tables 4, 8 and 9, etc.). Furthermore, the samples of Examples 54 and 55 were prepared in the same manner as in Example 37 except that the composition of the strip cast material (the composition of the rare earth magnet precursor) is changed as shown in Table 10.

### <Evaluation of Samples of Examples 22, 37, 44, 54 and 55 and Comparative Example 14>

The magnetic properties of each of the obtained samples were measured at room temperature by using Vibrating Sample Magnetometer (VSM). In addition, with respect to the core portion and the shell portion, the content ratio in a predetermined rare earth magnet was analyzed using Corrector-Spherical Aberration-Scanning Transmission Electron Microscope-Energy Dispersive X-ray Spectrometry (Cs-STEM-EDX), and the above-described a, b and b/a were determined. Furthermore, the thickness of the shell portion was determined.

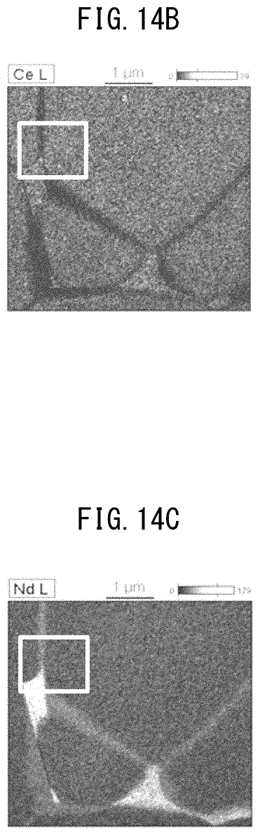

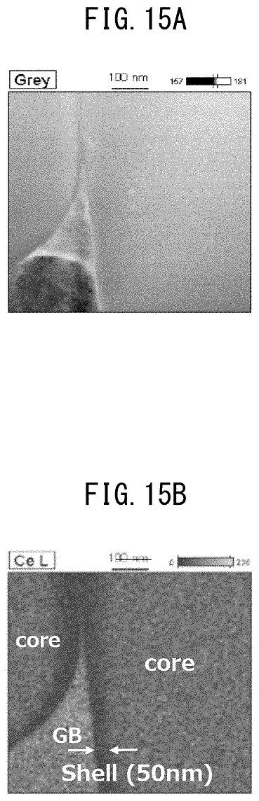

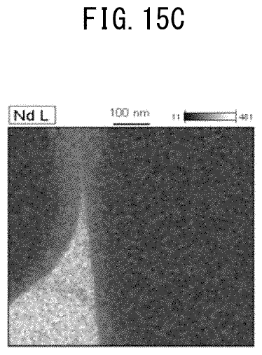

The results are shown in Table 10. In addition, FIG. 14A is a diagram illustrating the results when the sample of Example 37 is observed by Cs-STEM. FIG. 14B is a diagram illustrating the results when area analysis of Ce is performed using Cs-STEM-EDX with respect to the region shown in FIG. 14A. FIG. 14C is a diagram illustrating the results when area analysis of Nd is performed using Cs-STEM-EDX with respect to the region shown in FIG. 14A. FIG. 15A is a diagram illustrating the results when the portion surrounded by a square in FIG. 15A is enlarged and observed by Cs-STEM. FIG. 15B is a diagram illustrating the results when the portion surrounded by a square in FIG. 15A is enlarged and area analysis of Ce is performed using Cs-STEM-EDX. FIG. 15C is a diagram illustrating the results when the portion surrounded by a square in FIG. 15A is enlarged and area analysis of Nd is performed using Cs-STEM-EDX. In FIGS. 14B to 14C and FIGS. 15B and 15C, the bright field indicates that the concentration of the area-analyzed element is high.

TABLE 10

| | Rare Earth Magnet Precursor | | | | | | |
|---|---|---|---|---|---|---|---|
| | | | | Average | | | |
| | | | Volume | Particle | Volume | | |
| | | | Fraction | Diameter | Fraction | Modifier | |
| | | | of Main | of Main | of T2 | | Melting |
| | | | Phase | Phase | Phase | Composition | Point |
| | Composition (at %) | Type | (%) | (μm) | (%) | (molar ratio) | (° C.) |
| Comparative | Nd6.6Ce4.9La1.6FebalB6Cu0.1Ga0.3 | hot-plastic | 95.9 | 0.35 | 0.4 | Nd0.70Cu0.30 | 520 |
| Example 14 | | worked magnet | | | | | |
| Example 37 | Nd6.6Ce4.9La1.6FebalB6Cu0.1Ga0.3 | sintered | 95.9 | 6.1 | 0.4 | Nd0.90Cu0.10 | 848 |
| | | magnet | | | | | |
| Example 22 | Nd6.6Ce4.9La1.6FebalB6Cu0.1Ga0.3 | sintered | 95.9 | 6.1 | 0.4 | Nd0.80Fe0.20 | 685 |
| | | magnet | | | | | |
| Example 44 | Nd6.6Ce4.9La1.6FebalB6Cu0.1Ga0.3 | sintered | 95.9 | 6.1 | 0.4 | Nd0.80Fe0.10Al0.10 | 718 |
| | | magnet | | | | | |
| Example 54 | Nd2.5Pr0.7Ce7La3.5FebalB6.3Cu0.1Ga0.3 | sintered | 94.0 | 6.5 | 1.0 | Nd0.90Cu0.10 | 848 |
| | | magnet | | | | | |
| Example 55 | Nd9.3Ce3La1FebalB6.2Cu0.1Ga0.3 | sintered | 94.8 | 4.8 | 0.8 | Nd0.90Cu0.10 | 848 |
| | | magnet | | | | | |

| | | | | | | Heat | | |
|---|---|---|---|---|---|---|---|---|
| | Diffusion and Infiltration | | | | | Treatment | | |
| | Diffusion | Diffusion | R3 Diffusion | Diffusion | | Tempera- | | Residual |
| | Infiltration | Infiltration | Infiltration | Infiltration | | ture for | Coercive | Magnet- |
| | Ratio | Ratio | Ratio | Temperature | Cooling Rate | Optimization | Force | ization |
| | (mass ratio) | (molar ratio) | (molar ratio) | (° C.) | (° C./min) | (° C.) | (kA/m) | (T) |
| Comparative | 10 | 5.5 | 3.6 | 650 | 10 | — | 756.0 | 1.24 |
| Example 14 | | | | | | | | |
| Example 37 | 15 | 7.1 | 6.0 | 950 | 1 | 500 | 795.8 | 1.29 |
| Example 22 | 10 | 5.1 | 3.9 | 950 | 1 | — | 580.9 | 1.30 |
| Example 44 | 20 | 10.4 | 7.6 | 950 | 1 | — | 684.4 | 1.25 |
| Example 54 | 15 | 4.7 | 4.1 | 950 | 1 | 500 | 435.0 | 1.09 |
| Example 55 | 15 | 4.7 | 4.1 | 950 | 1 | 500 | 875.4 | 1.28 |

| | Rare Earth Element | | | | | | |
|---|---|---|---|---|---|---|---|
| | | | | Other Than Light Rare Earth Element | | | |
| | Light Rare Earth Element | | | Ratio 1 − a | Ratio 1 − b | | |
| | Light Rare Earth | Light Rare Earth | | Other Than Light | Other Than Light | | Shell |
| | Ratio a in | Ratio b in | | Rare Earth in | Rare Earth in | (1 − b)/ | Thickness |
| | Core Portion | Shell Portion | b/a | Core Portion | Shell Portion | (1 − a) | (nm) |
| Comparative | 0.47 | 0.30 | 0.64 | 0.53 | 0.70 | 1.32 | 20 |
| Example 14 | | | | | | | |
| Example 37 | 0.47 | 0.09 | 0.19 | 0.53 | 0.91 | 1.72 | 50 |
| Example 22 | 0.47 | 0.13 | 0.28 | 0.53 | 0.87 | 1.63 | 90 |
| Example 44 | 0.47 | 0.22 | 0.47 | 0.53 | 0.78 | 1.47 | 77 |
| Example 54 | 0.71 | 0.27 | 0.38 | 0.29 | 0.73 | 2.52 | 113 |
| Example 55 | 0.30 | 0.05 | 0.17 | 0.70 | 0.95 | 1.36 | 30 |

Note 1)
T2 Phase means R1.1Fe4B4 phase.
Note 2)
“Diffusion Infiltration Ratio (mass ratio)” means parts by mass (mass ratio) of modifier relative to 100 parts by mass of rare earth magnet precursor.
Note 3)
“Diffusion Infiltration Ratio (molar ratio)” means parts by mol (molar ratio) of modifier relative to 100 parts by mol of rare earth magnet precursor.
Note 4)
“R3 Diffusion Infiltration Ratio” means parts by mol (molar ratio) of R3 diffused and infiltrated relative to the total (100 parts by mol + q parts by mol) of rare earth magnet precursor and modifier when q parts by mol of modifier is diffused and infiltrated into 100 parts by mol of rare earth magnet precursor.
Note 5)
“Cooling Rate” means a cooling rate up to 500° C.
Note 6)
“—” in the column of “Heat Treatment Temperature for Optimization” means that heat treatment for optimization is not performed.

First, the method for determining a, b and b/a in the sample of Example 37 is described. When a section of the sample is observed by Cs-STEM, an image illustrated in FIG. 14A is obtained, but in this state, it is difficult to recognize between the main phase and the grain boundary phase and between the core portion and the sell portion. Therefore, utilizing the fact that the kinds of rare earth elements present in each of the main phase and the grain boundary phase and in each of the core portion and the shell portion and their content ratios are different, the regions of the main phase and the grain boundary phase as well as the regions of the core portion and the shell portion are discriminated.

In FIG. 14B and FIG. 14C, the region recognizable as particles is the main phase. In FIG. 14B and FIG. 14C, the outer edge of the region recognizable as particles (main phase) is included in the portion surrounded by a square, and therefore when the portion surrounded by a square is enlarged and observed (see, FIG. 15B and FIG. 15C), the outer edge of the main phase and the grain boundary phase can be recognized.

In FIG. 15B and FIG. 15C, the brightest portion is the grain boundary phase. As described above, the grain boundary phase does not have a distinct crystal structure but, as the entire grain boundary phase, is a “rare earth-rich phase” containing a larger amount of the rare earth element than the main phase, and therefor the position of the grain boundary phase appears as a bright field. In the case of the sample of Example 37, since a Nd_{0.9}Cu_{0.1} alloy is diffused and infiltrated as the modifier, the region of the grain boundary phase is especially bright in FIG. 15C (results of area analysis of Nd).

The dark field running along the grain boundary phase in FIG. 15B (results of area analysis of Ce) is a bright field area next to the grain boundary phase (the region that is less bright than, but is bright next to, the region of the grain boundary) in FIG. 15C (results of area analysis of Nd). Accordingly, it can be recognized that in this region, Ce is discharged and Nd is supplied. In addition, this region runs along the grain boundary phase, and therefore can be recognized as the shell portion. Furthermore, the region recognizable as particles, which is located on the opposite side of the grain boundary phase (brightest region) across the shell portion, is the core portion.

With respect to the core portion and the shell portion, which can be recognized in this way, when component analysis is performed using Cs-STEM-EDX, the results shown in Table 11 are obtained. Incidentally, in Table 11, the molar ratio of each element determined from the overall composition of the rare earth magnet precursor of Example 37 is shown together. This is determined as follows.

As seen from Table 10, the overall composition of the rare earth magnet precursor of Example 37 is represented by the formula: Nd_{6.6}Ce_{4.9}La_{1.6}Fe_{bal}B_{6.0}Cu_{0.1}Ga_{0.3}. This formula can also be represented by (Nd_{0.50}Ce_{0.38}La_{0.12})_{13.1}Fe_{bal}B_{6.0}Cu_{0.1}Ga_{0.3}. The rare earth magnet precursor has a main phase and a grain boundary phase. The grain boundary phase contains a larger amount of the rare earth element than the main phase, but in the case of containing two or more kinds of rare earth elements, the molar ratios of respective rare earth elements are almost the same between the main phase and the grain boundary phase. In the case of the rare earth magnet precursor of Example 33, the molar ratios of Nd, Ce, and La are 0.50, 0.38, and 0.12, respectively.

TABLE 11

| | Molar Ratio | | |
|---|---|---|---|
| | Nd | Ce | La |
| Core portion | 0.53 | 0.37 | 0.10 |
| Shell portion | 0.91 | 0.08 | 0.01 |
| Rare earth magnet precursor | 0.50 | 0.38 | 0.12 |

It can be understood from Table 11 that Nd is concentrated in the shell portion. In addition, the molar ratio in the core portion substantially coincides with the molar ratio in the rare earth magnet precursor. This means that the light rare earth element (Ce and La) is replaced, in the main phase, by the rare earth element (Nd) other than the light rare earth element by the diffusion and infiltration of the modifier but such a replacement does not occur in the core portion. In addition, the molar ratio in the rare earth magnet precursor is determined from the blending of raw materials at the time pf preparation of the rare earth magnet precursor and substantially coincides with the molar ratio in the shell portion, which is determined using Cs-STEM-EDX. From these, it can be said that the values of a, b and b/a determined based on the analysis results using Cs-STEM-EDX have high reliability.

From Table 10 in which a, band b/a determined as above are shown together, it could be confirmed that the samples of Examples having a, b and b/a satisfying predetermined ranges and having a predetermined shell thickness are excellent in both the coercive force and the residual magnetization.

These results could prove the effect of the rare earth magnet of the present disclosure and the production method thereof.

### REFERENCE SIGNS LIST

10 Main phase
12 Core portion
14 Shell portion
20 Grain boundary phase
22 Triple point
50 Rare earth magnet precursor
60 Modifier
62 Melt
100 Rare earth magnet of the present disclosure

1. A rare earth magnet comprising a main phase and a grain boundary phase present around the main phase, wherein the overall composition is represented, in terms of molar ratio, by the formula: (R²₍₁₋ₓ₎R¹ₓ)_{y}Fe_{(100-y-w-z-v)}Co_{w}B_{z}M¹ᵥ.(R³₍₁₋ₚ₎M²ₚ)_{q} (wherein R¹ is one or more elements selected from the group consisting of Ce, La, Y, and Sc, each of R² and R³ is one or more elements selected from the group consisting of Nd, Pr, Gd, Tb, Dy, and Ho, M¹ is one or more elements selected from the group consisting of Ga, Al, Cu, Au, Ag, Zn, In, and Mn, and unavoidable impurity elements, M² is composed of a transition metal element which is other than a rare earth element and can be alloyed with R³, and unavoidable impurity elements,
0.1≤x≤1.0,
12.0≤y≤20.0,
5.0≤z≤20.0,
0≤w≤30.0,
0≤v≤2.0,
0.05≤p≤0.40, and
0.1≤q≤15.0),
the main phase has an R₂Fe₁₄B-type (wherein R is a rare earth element) crystal structure,
the average particle diameter of the main phase is from 1 to 20 μm,
the main phase has a core portion and a shell portion present around the core portion,
the thickness of the shell portion is from 25 to 150 nm, and
with respect to the core portion, denoting a as the molar ratio of the total content of Ce, La, Y, and Sc relative to the total content of Ce, La, Y, Sc, Nd, Pr, Gd, Tb, Dy, and Ho, and with respect to the shell portion, denoting b as the molar ratio of the total content of Ce, La, Y, and Sc relative to the total content of Ce, La, Y, Sc, Nd, Pr, Gd, Tb, Dy, and Ho, these satisfy 0≤b≤0.30 and 0≤b/a≤0.50.

2. The rare earth magnet according to claim 1, wherein b satisfies from 0.09 to 0.27 and b/a satisfies from 0.17 to 0.47.

3. The rare earth magnet according to claim 1, wherein z is from 5.6 to 20.0.

4. A method for producing a rare earth magnet, comprising:
preparing a rare earth magnet precursor which includes a main phase and a grain boundary phase present around the main phase and in which the overall composition is represented, in terms of molar ratio, by the formula: (R²₍₁₋ₓ₎R¹ₓ)_{y}Fe_{(100-y-w-z-v)}Co_{w}B_{z}M¹_{y}(wherein R¹ is one or more elements selected from the group consisting of Ce, La, Y, and Sc, R² is one or more elements selected from the group consisting of Nd, Pr, Gd, Tb, Dy, and Ho, M¹ is composed of one or more elements selected from the group consisting of Ga, Al, Cu, Au, Ag, Zn, In, and Mn, and unavoidable impurity elements, 0.1≤x≤1.0, 12.0≤y≤20.0, 5.0≤z≤20.0, 0≤w≤8.0, and 0≤y≤2.0), the main phase has an R₂Fe₁₄B-type (wherein R is a rare earth element) crystal structure, the average particle diameter of the main phase is from 1 to 20 μm, and the volume fraction of the main phase is from 90 to 97%,
preparing a modifier having a composition represented, in terms of molar ratio, by the formula: R³₍₁₋ₚ₎M²ₚ (wherein R³ is one or more elements selected from the group consisting of Nd, Pr, Gd, Tb, Dy, and Ho, M² is composed of a transition metal element which is other than a rare earth element and can be alloyed with R³, and unavoidable impurity elements, and 0.05≤p≤0.40), and
bringing q parts by mol (0.1≤q≤15.0) of the modifier into contact with 100 parts by mol of the rare earth magnet precursor to diffuse and infiltrate from 3.7 to 10.0 parts by mol of R³ relative to the total of the rare earth magnet precursor and the modifier (100 parts by mol+q parts by mol) at a temperature of not less than the melting point of the modifier and from 750 to 1,000° C.

5. The method according to claim 4, wherein from 3.6 to 10.4 parts by mol of the modifier is diffused and infiltrated into 100 parts by mol of the rare earth magnet precursor.

6. The method according to claim 4, wherein from 3.8 to 7.8 parts by mol of R³ is diffused and infiltrated relative to the total of the rare earth magnet precursor and the modifier (100 parts by mol+q parts by mol).

7. The method according to claim 4, wherein
z in the formula representing the composition of the rare earth magnet precursor is from 5.6 to 20.0,
the grain boundary phase of the rare earth magnet precursor contains from 0 to 30.0 vol % of a phase having an R_{1.1}Fe₄B₄-type crystal structure relative to the entire rare earth magnet precursor, and
the composition of the modifier is represented, in terms of molar ratio, by the formula: R³₍₁₋ₛ₋ₜ₎FeₛM³ₜ (wherein M³ is composed of a transition metal element which is other than a rare earth element and can be alloyed with R³ and Fe, and unavoidable impurity elements, and 0.05≤s≤0.30, 0≤t≤0.20, and 0.05≤s+t≤0.40 are satisfied).

8. The method according to claim 4, wherein the rare earth magnet after diffusing and infiltrating the modifier into the rare earth magnet precursor is further heat-treated at 450 to 600° C.

9. The method according to claim 4, wherein after the diffusion and infiltration, the rare earth magnet precursor and the modifier are cooled at 0.1 to 10° C./min.

10. The method according to claim 4, wherein after the diffusion and infiltration, the rare earth magnet precursor and the modifier are cooled at 0.1 to 1° C./min.

11. The method according to claim 4, wherein the modifier is diffused and infiltrated into the rare earth magnet precursor at a temperature of not less than the melting point of the modifier and from 850 to 1,000° C.

12. The method according to claim 4, wherein the modifier is diffused and infiltrated into the rare earth magnet precursor at a temperature of not less than the melting point of the modifier and from 900 to 1,000° C.
